(19) United States
(12) Patent Application Publication
(10) Pub. No.: US 2017/0272783 A1
(43) Pub. Date: Sep. 21, 2017

(54) ARCHITECTURE FOR INTERCONNECTED SET-TOP BOXES

(71) Applicant: TELEFONAKTIEBOLAGET LM ERICSSON (PUBL), Stockholm (SE)

(72) Inventors: Alexander Bachmutsky, Sunnyvale, CA (US); Srinivas Kadaba, Fremont, CA (US)

(21) Appl. No.: 15/071,602

(22) Filed: Mar. 16, 2016

(51) Int. Cl. H04N 21/218; H04N 21/2225; H04L 29/06; H04N 21/2665; H04N 21/258; H04N 21/63; H04N 21/239

(52) U.S. Cl. CPC H04N 21/2181; H04N 21/632; H04N 21/2225; H04N 21/2393; H04N 21/2665; H04N 21/25808; H04L 65/4084

(57) ABSTRACT

An interconnected architecture for set-top boxes (STBs) configured to facilitate media streaming in a network environment. In one embodiment, a data center associated with the network environment includes a control plane manager operative to receive and process media requests from a plurality of subscriber devices, each subscriber device comprising at least a media renderer and a user interface operative with a virtual STB hosted at the data center. One or more vSTBs associated with a plurality of subscribers may be hosted at the data center, which may be logically organized into a number of mesh architectures. The control plane manager is further operative to determine if a request from a subscriber device for a particular content is for content that already exists at one or more vSTBs hosted in the data center, and if so, select an optimal vSTB that already supports a stream of the requested particular content for effectuating a media session with the subscriber device.

### FIELD OF THE DISCLOSURE

The present disclosure generally relates to communication networks. More particularly, and not by way of any limitation, the present disclosure is directed to a system and method for effectuating meshed interconnection architecture for a plurality of set-top boxes (STBs) in a content streaming environment.

### BACKGROUND

Current content streaming technologies present various challenges for both the end-user and the service provider. In most cases, the service provider has to “pay” extra (e.g., in terms of more network resources) to provide acceptable levels of video quality for a satisfying viewing experience. Whereas techniques such as predicting what kind of programming would a subscriber want in the future and pre-loading such content ahead of time have been advanced to address some of the ongoing challenges, several lacunae continue to exist in both Over-The-Top (OTT) as well as Internet Protocol TV (IPTV) delivery environments. Further, subscribers are increasingly expecting flexible behavior from their video service, including on-demand and broadcast offerings via IPTV platforms, to enhance their viewing options and features.

Technology developers are therefore continually looking to come up with innovations in the video streaming area, including developments in the customer premises equipment, as will be set forth in detail below.

### SUMMARY

The present patent disclosure is broadly directed to systems, methods, apparatuses as well as client devices and associated non-transitory computer-readable media for providing an interconnected architecture that includes set-top boxes (STBs) configured to facilitate media streaming in a network environment. In one embodiment, a data center associated with the network environment includes a control plane manager operative to receive and process media requests from a plurality of thin client subscriber devices, each device comprising at least a media renderer and a user interface operative with at least one virtual STB (vSTB) hosted at the data center. One or more vSTBs associated with a plurality of subscribers may be hosted at the data center, which may be logically organized into a number of mesh architectures. The control plane manager is further operative to determine if a request from a subscriber device for a particular content is for content that already exists at one or more vSTBs hosted in the data center, and if so, an optimal vSTB that already supports a stream of the requested particular content is selected for effectuating a media session with the subscriber device. In a further variation, another vSTB may be operative to serve a new subscriber, or the requested content may be shared between two or more vSTBs (e.g., using shared memory if both vSTBs are on the same server).

In a related aspect, an embodiment of a system is disclosed for facilitating media streaming in a network environment including a plurality of STBs, at least a portion which can be thick client STBs, also referred to as physical STBs or pSTBs, or at least another portion of which can be thin client STBs or vSTBs that may correspond to a plurality of virtual STBs., or a combination thereof, or in an all pSTB deployment or in an all vSTB deployment. Where one or more vSTBs are deployed, they may be instantiated in a data center of the network environment hosted by one or more servers. The system comprises, inter alia, a control plane manager operative to receive and process media requests from the plurality of STBs, wherein each STB includes at least a media renderer, a user interface and a local database storage of content downloaded for rendering, among others. The control plane manager is further operative to determine if a request from a first STB for a particular content is for content that already exists at one or more STBs of the network environment. If so, an optimal STB that already supports a stream of the requested particular content is selected for effectuating a media session to the first STB for streaming the requested particular content from the selected optimal STB.

In a further related aspect, an embodiment of a method for facilitating media streaming in a network environment is disclosed. The claimed embodiment comprises, inter alia, receiving a request for a particular content from a subscriber device and determining if the request is for content that already exists at one or more set-top boxes (e.g., pSTBs and/or vSTBs). If a copy of the requested content is already supported by or exists at multiple STBs, an optimal STB source is selected based on a number of performance criteria, e.g., latency thresholds, minimum throughput requirements, etc., for effectuating a media session between the optimal STB and the requesting STB device. In an example implementation involving a virtualized environment, vSTBs may be hosted by a media service data center associated with the plurality of subscribers.

Example STB interconnection architectures of the present disclosure include but not limited to partial or full logical mesh architectures, peer-to-peer (P2P) architectures, Software-Defined Network (SDN)-compliant architectures, multi-level hierarchical or nested connection architectures, multicast trees, and the like.

In a still further variation, an example media streaming network environment may include a combination of vSTBs as well as pSTBs and the control plane manager associated therewith may be configured to service requests emanating from either types of client devices for content. Accordingly, a media request from a thin client for a particular content may be at least partially serviced via a vSTB associated with the subscriber, a vSTB associated with another subscriber, a pSTB associated with the subscriber, a pSTB associated with another subscriber, or a combination thereof, or from the media service source, wherein the media streaming session may be dynamically switched depending on the interconnection architecture, network conditions, as well as other heuristics, among others, as will be set forth in detail hereinbelow.

Still further aspects of the present disclosure relate to a content popularity determination system and method operative with interconnected STBs configured to facilitate media streaming in a network environment. In one embodiment, download patterns may be monitored relative to accessing a particular content via a plurality of STBs (e.g., pSTBs and/or vSTBs) associated with one or more subscribers. Also monitored is whether the same particular content is shared by other STBs for downloading to other subscribers, wherein the STBs are logically organized into one or more local or distributed clusters or banks. Popularity-related metrics with respect to the particular content may be determined based on accessing of the particular content by the subscribers (e.g., from the media streaming servers) as well as sharing of the particular content by other STBs for downloading to the other subscribers. Multiple local STB banks, each being controlled by a corresponding STB controller, may be interconnected to form extended STB banks, which may be further organized into higher levels of groupings or assemblies, wherein the STB controllers may also be hierarchically connected to operate as a smart control plane for the entire media streaming network environment. For purposes of the present patent application, the terms “media” includes video, audio, or both, and these terms will be used synonymously with each other as well as with terms such as, e.g., “content”, “program”, etc. as will be set forth further below in respect of one or more embodiments of the present invention.

In still further aspects, one or more embodiments of a non-transitory computer-readable medium containing computer-executable program instructions or code portions stored thereon are disclosed for performing one or more embodiments of the methods set forth herein when executed by a processor entity of a network node, a client STB device, and the like. Further features of the various embodiments are as claimed in the dependent claims appended hereto.

One skilled in the art will recognize that embodiments of the present invention can significantly improve overall end-user video streaming experience in a network environment, with lower latencies and reduced jitter, facilitated by increased throughput, lower total system bandwidth and buffering requirements, etc., in addition to reducing service provider costs of media delivery. Not only features such as faster channel switching, customized provisioning of multiple video services and online user interfaces, and the like, can be advantageously implemented in the network, more efficient and reliable mechanisms for content popularity determinations and corresponding caching decisions may also be implemented in accordance with an embodiment of the present disclosure. With improved real-time knowledge of content popularity, additional avenues for potential advertising revenue may be realized. Additional benefits and advantages of the embodiments will be apparent in view of the following description and accompanying Figures.

### BRIEF DESCRIPTION OF THE DRAWINGS

Embodiments of the present disclosure are illustrated by way of example, and not by way of limitation, in the Figures of the accompanying drawings in which like references indicate similar elements. It should be noted that different references to “an” or “one” embodiment in this disclosure are not necessarily to the same embodiment, and such references may mean at least one. Further, when a particular feature, structure, or characteristic is described in connection with an embodiment, it is submitted that it is within the knowledge of one skilled in the art to effect such feature, structure, or characteristic in connection with other embodiments whether or not explicitly described.

The accompanying drawings are incorporated into and form a part of the specification to illustrate one or more exemplary embodiments of the present disclosure. Various advantages and features of the disclosure will be understood from the following Detailed Description taken in connection with the appended claims and with reference to the attached drawing Figures in which:

FIG. 1 depicts a generalized content streaming network environment wherein one or more embodiments of the present invention may be practiced for facilitating an interconnection architecture for a plurality of STBs;

FIG. 2 depicts another aspect of an example content streaming network environment that illustrates a subscriber premises having one or more thick-client STBs and/or one or more thin-client STBs for consuming content according to an embodiment of the present patent disclosure;

FIG. 3 depicts a block diagram of an STB according to an example embodiment;

FIG. 4 depicts a network architecture wherein a thin-client STB is operative to interact with one or more virtual STBs disposed in a data center or cloud network environment according to an example embodiment;

FIG. 5 depicts an example network function virtualization (NFV) architecture for facilitating a virtual STB infrastructure according to an embodiment;

FIG. 6 depicts an example Software-Defined Network (SDN) architecture wherein data plane applications such as STB nodes may be interconnected and controlled using a control plane according to one embodiment;

FIG. 7 depicts an example peer-to-peer (P2P) interconnection architecture for connecting STB nodes according to one embodiment;

FIG. 8 depicts an example hierarchical interconnection architecture for connecting STB nodes according to one embodiment;

FIG. 9 depicts an example shared buffer scenario wherein a plurality of STBs may be configured to access a common content stream according to one embodiment;

FIG. 10 illustrates an example user interaction scenario for consuming content using a vSTB implementation according to one embodiment;

FIG. 11 depicts a block diagram of an network element, node, subsystem or apparatus for effectuating control plane operations, among others, in a content streaming environment according to an example embodiment;

FIG. 12 depicts a flowchart of steps, acts, blocks and/or functions that may take place for effectuating content consumption in a network environment of the present invention;

FIG. 13 depicts a flowchart of additional/alternative steps, acts, blocks and/or functions that may take place in combination or sub-combination with an illustrative process of FIG. 12 according to additional/alternative embodiments;

FIGS. 14A-14C depict additional processes that may be effectuated for providing popularity-based analytics in an interconnected STB environment according to an embodiment of the present patent disclosure;

FIGS. 15A and 15B depict example vSTB localization architectures that may involve content popularity metrics for facilitating content consumption according to one or more embodiments;

FIG. 16 depicts an example hierarchical localization architecture involving multiple STBs and shared/distributed or localized content database(s) according to an embodiment;

FIG. 17 depicts an example thick-client STB localization architecture involving content popularity analytics in an interconnected STB environment according to an embodiment of the present patent disclosure; and

FIG. 18 depicts an example network architecture wherein thick-client STBs are operative to interact with one another for sharing content according to an embodiment.

### DETAILED DESCRIPTION OF THE DRAWINGS

In the following description, numerous specific details are set forth with respect to one or more embodiments of the present patent disclosure. However, it should be understood that one or more embodiments may be practiced without such specific details. In other instances, well-known hardware/software subsystems, components, structures and techniques have not been shown in detail in order not to obscure the understanding of the example embodiments. Accordingly, it will be appreciated by one skilled in the art that the embodiments of the present disclosure may be practiced without having to reference one or more such specific components. It should be further recognized that those of ordinary skill in the art, with the aid of the Detailed Description set forth herein and taking reference to the accompanying drawings, will be able to make and use one or more embodiments without undue experimentation.

Additionally, terms such as “coupled” and “connected,” along with their derivatives, may be used in the following description, claims, or both. It should be understood that these terms are not necessarily intended as synonyms for each other. “Coupled” may be used to indicate that two or more elements, which may or may not be in direct physical or electrical contact with each other, co-operate or interact with each other. “Connected” may be used to indicate the establishment of communication, i.e., a communicative relationship, between two or more elements that are coupled with each other. Further, in one or more example embodiments set forth herein, generally speaking, an element, component or module may be configured to perform a function if the element is capable of performing or otherwise structurally arranged to perform that function.

As used herein, a network element or node may be comprised of one or more pieces of service network equipment, including hardware and software that communicatively interconnects other equipment on a network (e.g., other network elements, end stations, etc.), and is adapted to host one or more applications or services, either in a virtualized or non-virtualized environment, with respect to a plurality of subscribers and associated user equipment that are operative to receive/consume content in a network infrastructure adapted for streaming media content using one or more of a variety of access networks, transmission technologies, architectures, streaming protocols, etc. As such, some network elements may be disposed in a wireless radio network environment whereas other network elements may be disposed in a public packet-switched network infrastructure, including or otherwise involving suitable content delivery network (CDN) infrastructure. Further, suitable network elements operative with one or more embodiments set forth herein may involve terrestrial and/or satellite broadband delivery infrastructures, e.g., a Digital Subscriber Line (DSL) architecture, a Data Over Cable Service Interface Specification (DOCSIS)-compliant Cable Modem Termination System (CMTS) architecture, a suitable satellite access network architecture or a broadband wireless access network architecture, and the like. Additionally, some network elements in certain embodiments may comprise “multiple services network elements” that provide support for multiple network-based functions (e.g., A/V media delivery policy management, session control, QoS policy enforcement, bandwidth scheduling management, subscriber/device policy and profile management, content provider priority policy management, streaming policy management, and the like), in addition to providing support for multiple application services (e.g., data and multimedia applications). Example subscriber end stations or client devices may comprise a variety of content recording, rendering, and/or consumption devices operative to receive media content using a plurality of media delivery or streaming technologies. Accordingly, such client devices may include set-top boxes (STBs), networked TVs, personal/digital video recorders (PVR/DVRs), networked media projectors, portable laptops, netbooks, palm tops, tablets, smartphones, multimedia/video phones, mobile/wireless user equipment, portable media players, portable gaming systems or consoles (such as the Wii®, Play Station 3®, etc.) and the like, which may access or consume content/services provided via a suitable high speed broadband connection in combination with one or more embodiments set forth herein.

One or more embodiments of the present patent disclosure may be implemented using different combinations of software, firmware, and/or hardware. Thus, one or more of the techniques shown in the Figures (e.g., flowcharts) may be implemented using code and data stored and executed on one or more electronic devices or nodes (e.g., a subscriber client device or end station, a network element, etc.). Such electronic devices may store and communicate (internally and/or with other electronic devices over a network) code and data using computer-readable media, such as non-transitory computer-readable storage media (e.g., magnetic disks, optical disks, random access memory, read-only memory, flash memory devices, phase-change memory, etc.), transitory computer-readable transmission media (e.g., electrical, optical, acoustical or other form of propagated signals—such as carrier waves, infrared signals, digital signals), etc. In addition, such network elements may typically include a set of one or more processors coupled to one or more other components, such as one or more storage devices (e.g., non-transitory machine-readable storage media) as well as storage database(s), user input/output devices (e.g., a keyboard, a touch screen, a pointing device, and/or a display), and network connections for effectuating signaling and/or bearer media transmission. The coupling of the set of processors and other components may be typically through one or more buses and bridges (also termed as bus controllers), arranged in any known (e.g., symmetric/shared multiprocessing) or heretofore unknown architectures. Thus, the storage device or component of a given electronic device or network element may be configured to store code and/or data for execution on one or more processors of that element, node or electronic device for purposes of implementing one or more techniques of the present disclosure.

Referring now to the drawings and more particularly to FIG. 1, depicted therein is a generalized content streaming network environment 100 wherein one or more embodiments of the present invention may be practiced with respect to facilitating an interconnection architecture for a plurality of set-top boxes (STBs). Additionally, the content streaming network environment 100 may also be illustrative with respect to providing a distributed architecture for content popularity determination within an operator network serving a plurality of interconnected STBs. It will be realized that one or more embodiments set forth herein may be advantageously practiced in combination with bandwidth management techniques, delivery optimization methodologies, etc., for example, responsive to an STB's capabilities, characteristics, associated or integrated player device/display characteristics and configurations, network/connection conditions, and the like, although it is not necessary that such features be included in a particular embodiment. In general, the terms “program”, “program content”, “media content,” “media asset” or “content file” (or terms of similar import) as used in reference to at least some embodiments of the present patent disclosure may include digital assets or program assets such as any type of audio/video (A/V) content comprising live capture media or static/stored on-demand media that can be streamed to an STB, e.g., network television (TV) shows or programs, pay TV broadcast programs via cable networks or satellite networks, satellite TV shows, IPTV programs, Over-The-Top (OTT) and Video-On-Demand (VOD) or Movie-On-Demand (MOD) shows or programs, time-shifted TV (TSTV) content, etc., that may be delivered using any number/type of technologies, physical media, and/or protocols, etc. Accordingly, example end-to-end delivery platforms may comprise one or more core networks, access networks, edge networks, a network of networks, overlay of networks, private networks, public networks, wired communications networks, power line communications networks, mobile communications networks, private/public/hybrid content delivery networks, managed IPTV networks, unmanaged OTT media delivery networks, etc., using various delivery technologies such as adaptive bitrate (ABR) streaming technologies, including multicast ABR, unicast ABR, progressive download technologies, Transport Stream (TS) technologies, etc. Further, the diverse content provided by various content sources, e.g., as broadly represented by live media sources 102-1 to 102-N and VOD sources 104-1 to 104-M, may be streamed using various streaming protocols such as e.g., Microsoft® Silverlight® Smooth Streaming, HTTP streaming (for instance, Dynamic Adaptive Streaming over HTTP or DASH, HTTP Live Streaming or HLS, HTTP Dynamic Streaming or HDS, etc.), Icecast, RTP/RTSP (Real-time Transport Protocol and Real-Time Streaming Protocol), and so on.

In addition, one skilled in the art will recognize that the network environment 100 may be architected as a hierarchical organization wherein the various content sources and associated media processing systems (media encoders, segmentation and packaging, etc.), back office management systems, subscriber/content policy and QoS management systems, bandwidth allocation modules, and the like may be disposed at different hierarchical levels of the network architecture in an illustrative implementation, e.g., super headend (SHE) nodes, regional headend (RHE) nodes, video hub office (VHO) nodes, etc. that ultimately provide the media content streams to one or more serving edge node portions and associated access networks for further distribution to subscribers. As one skilled in the art will recognize, such access/edge networks may involve DSL networks, DOCSIS/CMTS networks, radio access network (RAN) infrastructures, a CDN architecture, a metro Ethernet architecture, and/or a Fiber to the X (home/curb/premises, etc., FTTX) architecture, a Hybrid Fiber-Coaxial (HFC) network infrastructure, etc., wherein suitable network elements such as DSL Access Multiplexer (DSLAM) nodes, CMTS nodes, edge QAM devices/hubs, etc. may be provided. Where a CDN implementation is involved as part the network environment 100, such an implementation may involve one or several central origin server nodes, regional nodes and a plurality of edge delivery nodes serving the subscribers, in addition to redirector nodes, subscriber management back office nodes, etc. Also, in a switched digital video (SDV) architecture that may be provided as part of the network environment 100, management entities such as session resource manager (SRM) nodes and edge resource manager (ERM) nodes may be disposed at suitable network levels as with respect to serving the subscribers. For the sake of simplicity, various such network entities that may be provided as part of an example implementation of a content delivery platform of the network environment 100 are not specifically depicted in FIG. 1. Rather, a network 103 including entities and functionalities described in detail further below is shown as a portion of—or operating in association with—any type of specific content delivery platforms or implementations set forth above, without limitation, wherein the network 103 is illustrative of appropriate infrastructure for facilitating data plane communications (e.g., bearer traffic including audio, video, media and/or data) as well as control plane communications (e.g., control signaling, either in-band, out-of-band, or sideband, etc.) within an STB interconnection architecture.

In accordance with the teachings of the present invention, interconnectable subscriber STBs may be provided as information appliances having a range of hardware/software components and functionalities depending on partitioning, virtualization, end user equipment integration, and the like, that can be disposed in various content streaming implementations of the network environment 100. In one embodiment, STBs may be provided as heavyweight or “thick client” devices having a broader range of functionalities that can operate as traditional STBs disposed in subscriber premises (e.g., in homes, offices, etc.) in addition to extra features and functions for facilitating an interconnected architecture under a control plane manager as will be set forth below. For purposes of the present patent application, such STBs may be referred to as physical STBs (pSTBs) or full-size STBs or terms of similar import. In another embodiment, STBs may be configured as lightweight or “thin client” devices having just enough structural components and functionality, e.g., modulation/demodulation, decryption/descrambling, rendering, and an interface to launch a browser and interactivity with a cloud-based virtualized STB (vSTB) architecture, etc., that may also be disposed in customer premises, wherein the cloud-based vSTB architecture may be configured to include one or more vSTBs that correspond to a thin client STB disposed in customer premises and a plurality of vSTBs may be interconnected in a suitable architecture under a control plane manager. In such an embodiment, various other STB functionalities such as, e.g., user interface, one or more electronic program guides (EPGs), IP routing, Dynamic Host Configuration Protocol (DHCP) functionality, Network Address Translation functionality, firewall functionality, as well as several value-added functions relating to interactive TV, digital video recording and gaming, advanced pay-TV functionality, middleware applications for providing enhanced user viewing experience, customizable premium content and advertisement insertion, etc., may be virtualized in the cloud (e.g., as a multi-tenant data center supporting suitable network function virtualization (NFV) architectures with respect to one or more video service operators). Accordingly, it should be appreciated that in such an environment, the role of a thin client STB or connected appliance may simply be limited to decode and render video for presentation at a suitable display device, thereby allowing for a vast array of cloud-based services to be implemented by various video service operators with increased service velocity.

In still further embodiments, STBs may not necessarily be disposed in a wired premises; rather, they may be provided as part of untethered communications/entertainment/gaming devices or appliances, having either thick client functionality or thin client functionality depending on implementation. Additionally, for purposes of at least certain embodiments, the terms customer STBs or customer premises equipment (CPE) STBs or terms of similar import may broadly refer to standalone tethered thick client STBs, standalone tethered thin client STBs, STBs integrated with other tethered or untethered subscriber devices, or STB functionalities in various other combinations. By way of illustration, a plurality of thick client STBs 106-1 to 106-L and a plurality of thin client STBs 108-1 to 108-K, which are generally representative of the different types of the STB embodiments set forth above, are shown in respective communicative relationships with network portion 103, wherein a control plane manager 110 associated with the network control plane is operative to facilitate control plane communications associated with the various STBs of a video operator's streaming infrastructure. Further, the control plane manager 110 may be operatively coupled to a plurality of vSTBs 114-1 to 114-P, one or more shared/distributed content databases 114 and one or more distributed content popularity engines 116 via a variety of architectures 112, as will be described in detail further below.

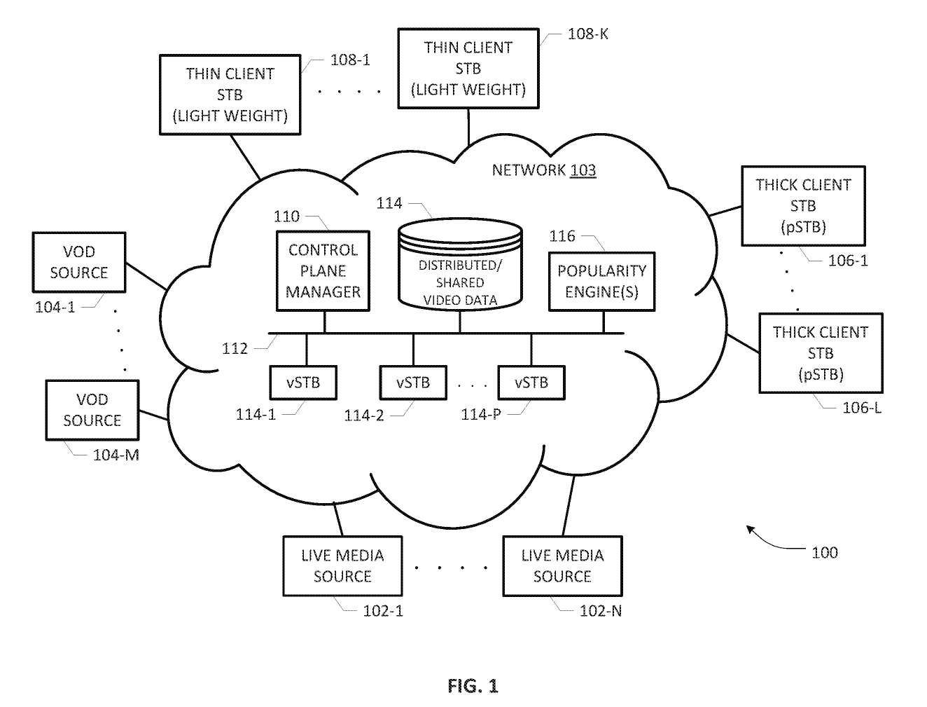

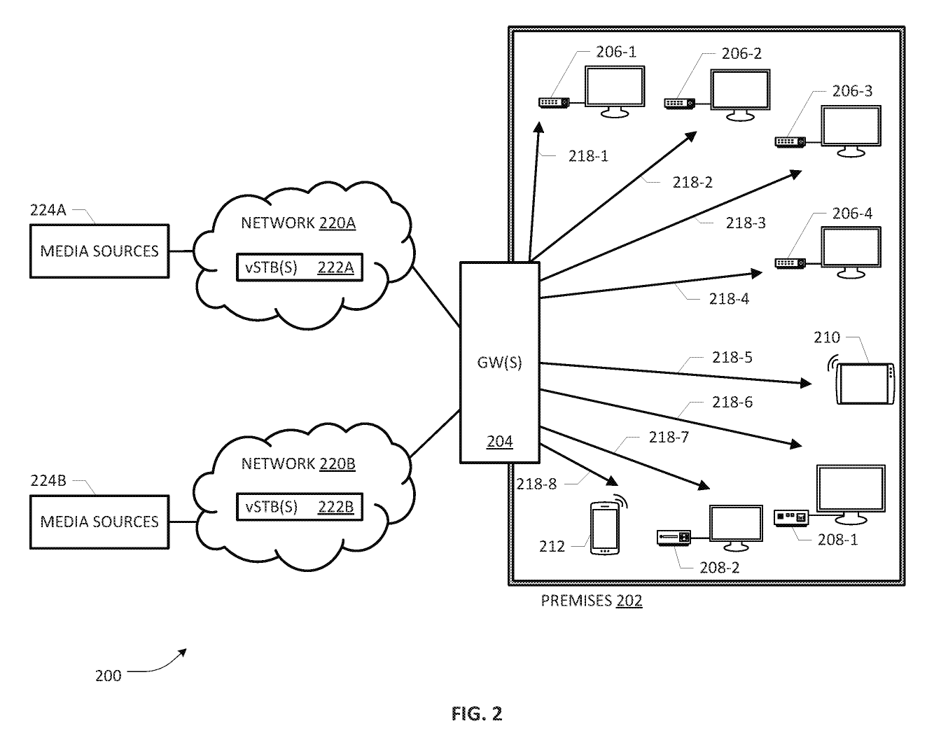

FIG. 2 depicts an example content streaming network environment 200 that illustrates a subscriber premises 202 having one or more thick-client STBs and/or one or more thin-client STBs for consuming content according to an embodiment of the present patent disclosure. One skilled in the art will recognize upon reference hereto that the example streaming environment 200 is illustrative of a more particularized aspect of the network environment 100 described above. One or more premises gateways (GWs) 204 are operative to with respect to facilitating satellite, cable and/or terrestrial TV/video services to the subscriber premises 202 received via applicable broadband communication pipes supported by suitable network infrastructure. Appliances 206-1 to 206-4 are representative of thin client STBs whereas appliances 208-1 and 208-2 are representative as thick client STBs, wherein the STB functionalities may be implemented in a variety of hardware/software configurations, e.g., network-connected media players (e.g., Blu-Ray disc players), gaming systems or consoles (such as the Wii®, Play Station® 3 or 4, Xbox®, etc.), branded STB equipment such as TiVo®, as well as part of streaming player boxes, sticks, dongles or hubs such as Fire TV, Apple TV, Google Chromecast, Roku, Western Digital TV (WDTV), etc. that may be connected to TVs or other display devices. Also, mobile communications equipment such as tablets, phablets, smartphones, generally represented by devices 210, 212, that may receive streaming media via GW 204 while in the premises 202 may also include STB functionalities as pointed out previously. As illustrated, some STB clients may be connected to corresponding external display devices while others may be integrated into smartTV appliances. In a still further variation, some STB clients may be operative as or with just media storage appliances of the subscriber premises 202. By way of further illustration, reference numerals 218-1 to 218-8 are representative of connections between GW 204 and the various premises equipment set forth above.

Networks 220A/220B, which may be roughly representative of network portion 103 shown in FIG. 1, exemplify two separate video service provider networks serving the premises 202, which are operatively coupled to one or more respective media sources 224A and 224B. Each network 220A, 220B may host a corresponding NFV environment operative to support a plurality of vSTBs 222A/222B for interfacing with one or more thin STB clients of the subscriber premises, although it is not necessarily limited such an association between vSTBs and the premises thin STB clients. As will be seen below, the disclosed embodiments may also include an implementation scenario where vSTBs could even be paired with thick clients at least for some subset of contents, while another subset is directly served by a thick client.

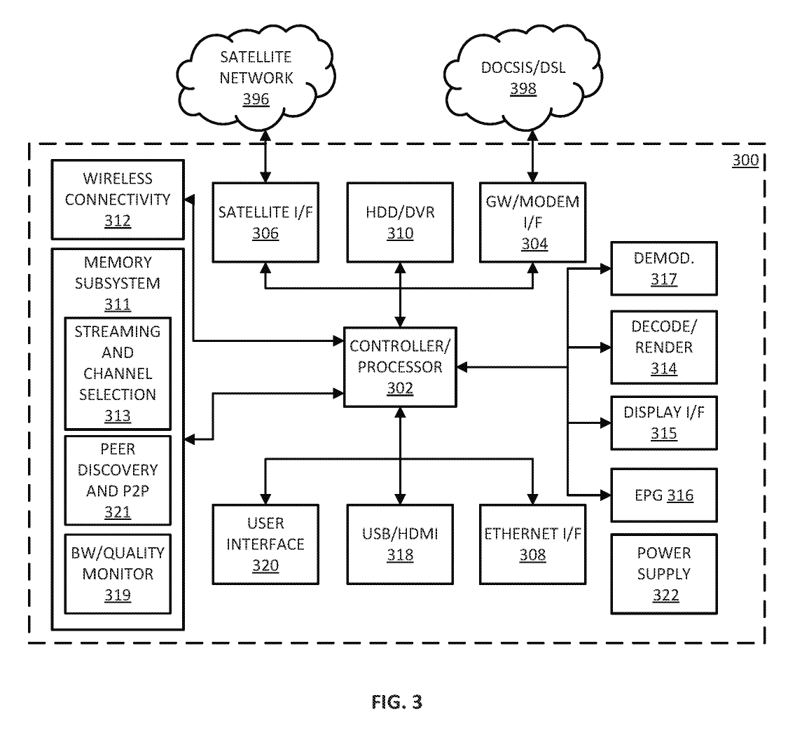

Broadly, depending on service providers' infrastructure, signal sources may comprise Ethernet cables, satellite dishes, coaxial cables, telephone lines, broadband over power lines, or even VHF/UHF antennas, for media delivery. In general, STBs may be configured to operate with one or more coder-decoder (codec) functionalities based on known or hereto unknown standards or specifications including but not limited to, e.g., Moving Pictures Expert Group (MPEG) codecs (MPEG, MPEG-2, MPEG-4, etc.), H.264 codec, High Efficiency Video Coding or HEVC (H.265) codec, and the like. FIG. 3 depicts a block diagram of a generalized STB according to an example embodiment, wherein one or more functionalities and components may be partitioned for virtualization in a number of ways depending on specific implementation. By way of illustration, in one embodiment, STB 300 may be exemplified as a thick client STB device having a local recorder 310 for storing downloaded media, which may be shared by other STBs disposed in an interconnection architecture. One or more controllers/processors 302 are provided for the overall control of STB 300 and for the execution of various stored program instructions embodied in a memory 313, e.g., as a streaming client application or browser having recorder/channel service selection logic or capability that may be provided as part of a memory subsystem 311 of the client device 300. In an example embodiment, the recorder/channel service selection logic 313 may be interfaced with video quality monitoring as well as connection bandwidth monitoring functionalities or modules 319 for providing local network condition information to one or more higher level controllers disposed in an interconnected STB architecture of the present invention set forth below. Controller/processor complex referred to by reference numeral 302 may also be representative of other specialty processing modules such as graphic processors, video processors, digital signal processors (DSPs), and the like, operating in association with suitable video and audio interfaces (not specifically shown). Appropriate interfaces such as I/F modules 304 and 306 involving or operating with tuners, demodulators, descramblers, MPEG/H.264/H.265 decoders/demuxes may be included for processing and interfacing with media content signals received via a DSL/CMTS network 398 or a satellite network 396 via a managed network delivery platform or an unmanaged OTT delivery platform. Example demodulators 317 may include NTSC demodulator(s) and/or ATSC/PAL demodulator(s), and the like. A decode/renderer 314 is operative in conjunction with the streaming client and recording selection module 313 for generating appropriate video driver signals with respect to local consumption/display of the content via a local display interface or an external connected display interface 315. Additional I/O interfaces such as EPG interface 316 for identifying media service channels, user interface 320, USB/HDMI ports 318, Ethernet I/F 308, and short-range and wide area wireless connectivity interfaces 312 are also provided. As noted previously, local recorder 310 may comprise a hard disk drive (HDD) or DVR system for local storage of all sorts of program assets such as A/V media, TV shows, movie titles, multimedia games, etc. as well as analytics information that may be further used for user-aware content and delivery optimization, popularity determination, and the like that may be shared in an example STB interconnection architecture of the present invention. Where a peer-to-peer (P2P) STB interconnection architecture is implemented, which will be described in additional detail further below, a peer discovery and P2P communications module 321 may be provided as part of the memory subsystem 311 that may comprise one or more suitable persistent, non-volatile memory modules or blocks in certain hardware/firmware implementations. In a further embodiment, where the STB device 300 is disposed in a Software-Defined Network (SDN) architecture, appropriate SDN interfacing with an SDN controller may be provided. In a still further embodiment involving presence-based interconnectivity, a suitable presence agent or presentity may also be included as part of the client device 300. A suitable power supply block 322 may be included (e.g., AC/DC power conversion) to provide power for the device 300. It should be appreciated that the actual power architecture for the client device 300 may vary by the partitioning or virtualization of the STB (i.e., “thickness” or “thinness” of the device), in addition to the hardware platforms used, e.g., depending upon the core SoC (System-on-Chip), memory, analog front-end, analog signal chain components and interfaces used in the specific platform, and the like,

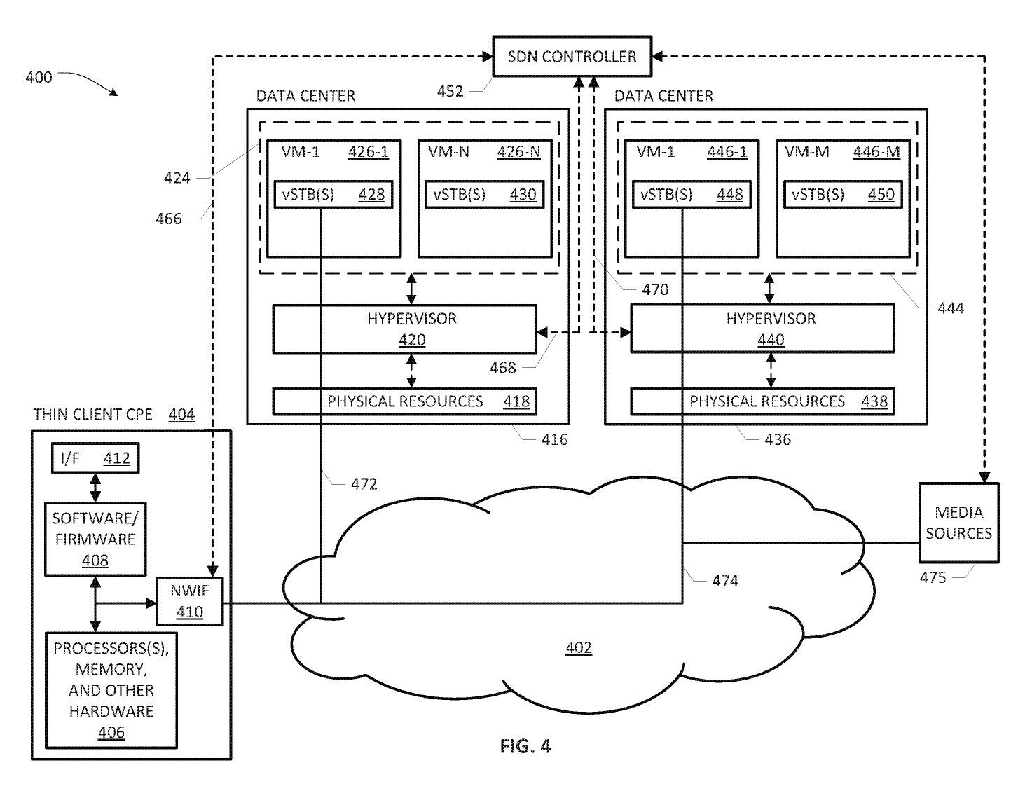

Turning to FIG. 4, a network architecture is shown wherein a thin-client STB is operative to interact with one or more virtual STBs disposed in a data center or cloud network environment 400 according to an example embodiment. By way of illustration, the example cloud network environment 400 is representative of an implementation of the network environment 100 discussed hereinabove with respect to FIG. 1, where an example thin client STB or associated end station or CPE 404 is connected to a packet-switched network or an overlay CDN 402 (e.g., the Internet-based or private CDN) for accessing cloud-based resources (e.g., applications, storage, vSTB functions or nodes etc.) disposed in one or more data centers 416, 436 operative for supporting video streaming services from a plurality of media sources 475. As such, the cloud-based data centers 416, 436 may be provided as part of a public cloud, a private cloud, or a hybrid cloud, and for cooperation with CPE STB 404, may be disposed in as SDN infrastructure using known or heretofore unknown protocols such as, e.g., OpenFlow (OF) protocol, Forwarding and Control Element Separation (ForCES) protocol, OpenDaylight protocol, and the like. An example SDN architecture typically involves separation and decoupling of the control and data forwarding planes of the network elements, whereby network intelligence and state control may be logically centralized and the underlying network infrastructure is abstracted from the applications. One implementation of an SDN-based network architecture may therefore comprise a network-wide control platform, executing on one or more servers, which is configured to oversee and control a plurality of data application nodes, functions or switches that may be virtualized in the cloud. Accordingly, a standardized interfacing may be provided between the network-wide control platform (which may be referred to as “SDN controller” 452 for purposes of some embodiments of the present patent application) and the various components such as data centers 416, 436 and CPE nodes 404, thereby facilitating high scalability, flow-based traffic control, multi-tenancy and secure infrastructure sharing, virtual overlay networking, efficient load balancing, and the like, in addition to facilitating virtualization of STB functions as well as supporting an SDN-based vSTB interconnection architecture.

As SDN-compatible infrastructures, data centers 416, 436 may be implemented in an example embodiment as an open source cloud computing platform for public/private/hybrid cloud arrangements, e.g., using OpenStack and Kernel-based Virtual Machine (KVM) virtualization schemes. As such, an example data center virtualization architecture may involve providing a virtual infrastructure for abstracting or virtualizing a vast array of physical resources such as compute resources (e.g., server farms based on blade systems), storage resources, and network/interface resources, wherein specialized software called a Virtual Machine Manager or hypervisor allows sharing of the physical resources among one or more virtual machines (VMs) or guest machines executing thereon. Each VM or guest machine may support its own OS and one or more applications, and one or more VMs may be logically organized into a virtual LAN using an overlay technology (e.g., a Virtual Extensible LAN (VxLAN) that may employ VLAN-like encapsulation techniques to encapsulate MAC-based OSI Layer 2 Ethernet frames within Layer 3 UDP packets) for achieving further scalability. By way of illustration, data centers 416 and 436 are exemplified with respective physical resources 418, 438 and VMM or hypervisors 420, 440, and respective plurality of VMs 426-1 to 426-N and 446-1 to 446-M that are logically connected in respective VxLANs 424 and 444 in an example implementation. As further illustration, each VM may support one or more applications including, e.g., vSTB application(s) 428 executing on VM 426-1, vSTB application(s) 430 executing on VM 426-N, vSTB application(s) 448 executing on VM 446-1, and vSTB application(s) 450 executing on VM 446-M, wherein vSTB applications may correspond to groups of subscribers or subscriber CPE STBs that consume media provided by one or more media service providers, cable companies, OTT content provider networks, managed CDN providers, etc. based on various types of subscription/registration mechanisms and intra- and inter-network service level agreements.

Continuing to refer to FIG. 4, although not specifically shown therein, hypervisors 420, 440 may be deployed either as a Type I or “bare-metal” installation (wherein the hypervisor communicates directly with the underlying host physical resources) or as a Type II or “hosted” installation (wherein the hypervisor may be loaded on top of an already live/native OS that communicates with the host physical infrastructure). It should be noted that vSTBs could be implemented as containers without VMs or even in a bare metal implementation not using any hypervisor in certain additional or alternative arrangements.

As described above, thin client STB 404 is an broadband-connected communication device or Internet appliance that may be deployed as a scaled down version of an STB such as STB 300, with enough functionality for carrying out decoding and rendering content media signals received pursuant to interacting with one or more vSTBs of the data centers 416, 436 that correspond to the subscriber associated with the thin client STB. Accordingly, thin client STB 404 may comprise sufficient processing, memory and other hardware, shown generally at reference numeral 406 operative with a software/firmware environment 408 for executing a media browser application (e.g., an HTTP client) and associated decode/descramble processing and rendering, etc. For purposes of input/output interaction, thin client STB 404 may be provided with a user interface 412 operative with a remote control device or integrated within a CPE that supports touchscreen, keypad, or other types of user inputs. A network interface 410 is exemplary of any of the wired/wireless interfaces provided as part of STB 300 shown in FIG. 3.

As part of the SDN-based architecture, thin client STB 404 and vSTBs of respective data centers 416, 436 are operable to communicate with SDN controller 452 via suitable protocol control channels 466, 468 or 470, wherein the SDN controller 452 may also contain a virtual switch in addition to the hypervisor (e.g., OF protocol control channels in one implementation). Appropriate data paths or tunnels 472, 474 may be effectuated by the SDN controller between the CPE and data center's vSTB entities that allow media stream flows from shared/virtualized content databases associated with the vSTBs, media streaming servers of the video service operators, or a combination thereof, depending on availability of cached content at the data centers, popularity determinations, vSTB optimization relative to the logical/physical location of the thin client STB, network congestion and bandwidth conditions, device/rendering capabilities of the thin client STB, etc., as well as applicable service-level agreement (SLA) parameters between the thin client STB, vSTBs and any media streaming services.

Although vSTB 428 and vSTB 448 of the data centers are shown in an operative relationship with thin client STB 404, a subset of the vSTBs may also be paired with one or more thick client STBs also (not specifically shown) in an example streaming network environment. All such variations, modifications, additions, involving vSTB associations with thin clients, thick clients, or a combination thereof are contemplated to be within the scope of the environment depicted in FIG. 4.

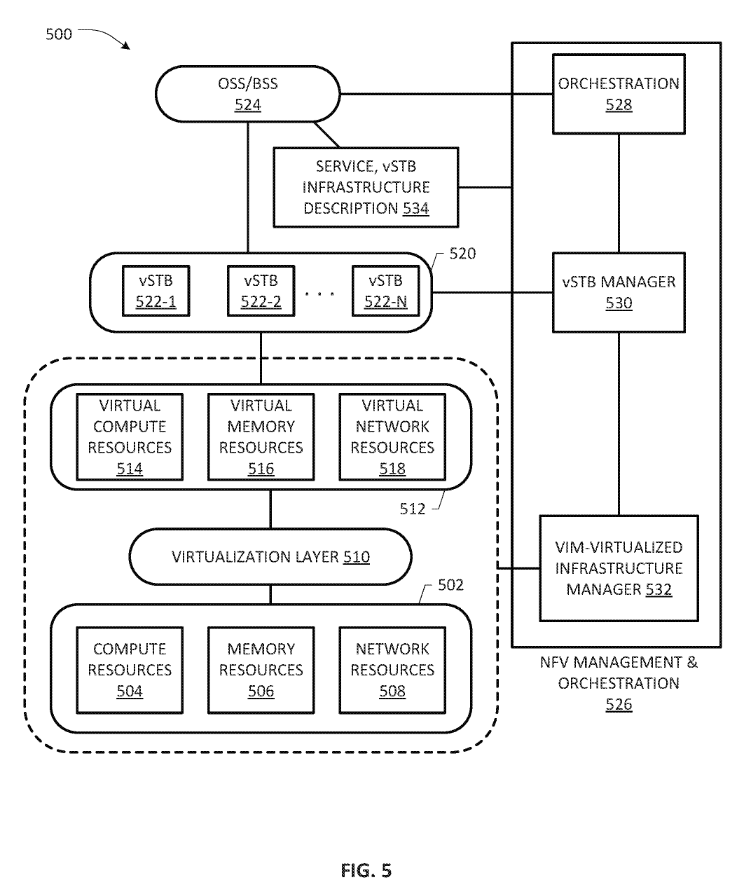

FIG. 5 depicts an example network function virtualization (NFV) architecture 500 for facilitating a vSTB interconnection infrastructure that may be employed in an example streaming network environment according to an embodiment, e.g., in association with network environments 100, 200 or 400 described hereinabove. Various physical resources, software/firmware functionalities, and services relative to STBs of the streaming network may be realized as virtual appliances wherein the resources and service functions are virtualized into suitable virtual network functions (VNFs) via a virtualization layer 510, which may be aggregated into individual vSTBs depending on the different video services being supported. Resources 502 comprising compute resources 504, memory resources 506, and network infrastructure resources 508 are virtualized into corresponding virtual resources 512 wherein virtual compute resources 514, virtual memory resources 516 and virtual network resources 518 are collectively operative to support a vSTB layer 520 including a plurality of vSTBs 522-1 to 522-N. One skilled in the art will recognize that virtualization layer 510 is also sometimes referred to as virtual machine monitor (VMM) or hypervisor described in the data center architecture of FIG. 4, which together with the virtual resources 512 as well as vSTBs layer 520 may comprise a NFV infrastructure (NFVI) of the streaming network environment in one aspect. As note above, in additional or alternative aspects, bare metal implementation of vSTBs may be realized even without a hypervisor. Overall NFV management and orchestration functionality 526 may be supported by a virtualized infrastructure manager (VIM) 532, a VNF/vSTB manager 530 and an orchestrator 528, wherein VIM 532 and VNF/vSTB manager 530 are interfaced with NFVI layer and VNF/vSTB layer, respectively. An Operation Support System (OSS) and/or Business Support System (BSS) component or element 524 is responsible for network-level functionalities such as network management, fault management, configuration management, service-level management, and subscriber management, etc., which may interface with VNF/vSTB layer 520 and NFV orchestration 528 via suitable interfaces. In addition, OSS/BSS 524 may be interfaced with a configuration module 534 for facilitating service, vSTB and infrastructure description input. Broadly, NFV orchestration 528 may involve generating, maintaining and tearing down of vSTBs supported by corresponding VNFs, depending on dynamic conditions of video streaming services being created and consumed. Further, NFV orchestrator 528 is also responsible for global resource management of NFVI resources, e.g., managing compute, storage and networking resources among multiple VIMs in the streaming network.

Based on the foregoing, it should be appreciated that it is not necessary to have a one-to-one mapping or correspondence relationship between a subscriber's thin client STB and a vSTB disposed at a data center. For example, the thin client STB may support rendering of an arbitrary number of separate video services on a single display screen split into multiple windows, with each being fed by a different vSTB. In an illustrative scenario where a subscriber has subscriptions to, e.g., Hulu, Netflix, Amazon and Comcast video services, each service may provide its own vSTB for the subscriber (which may be hosted in the same data center or different data centers) that can feed respective media streams to the subscriber's thin client STB renderer. The renderer may process all four streams simultaneously for display in a 4-way split window of the display device or on four separate connected display devices, whereupon the subscriber may focus on just one service or any subset of the four services simultaneously.

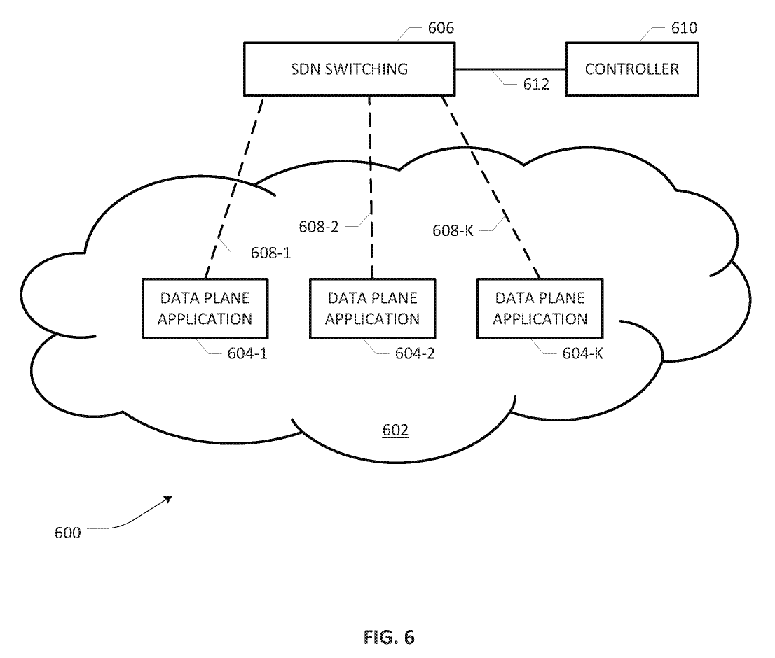

FIG. 6 depicts a further generalization of an example SDN architecture 600 wherein thick client STBs as well as thin client STBs and associated vSTBs may be treated as generalized data plane applications that may be interconnected and controlled using a control plane manager in according to one embodiment. As illustrated, data plane applications 604-1 to 604-K are representative of thick client physical STBs (pSTBs), vSTBs, and associated thin client STBs, each of which having a control path connection 608-1 to 608-K to a forwarding/switching element 606 that is coupled to a controller 610 pursuant to an SDN protocol. As discussed previously, the control plane entities in such an architecture may be configured to facilitate appropriate data path connections between the various STBs (and video streaming service servers, where determined to be necessary) using a data plane network 602 so the video assets of an entire video streaming operator infrastructure may be shared by the STBs in order to provide better user experience and support overall lower resource requirements (e.g., in terms of reduced networking throughput, reduced local memory requirements, less CPU utilization, etc.), in addition to achieving lower latencies and faster channel changes.

Broadly, in one implementation of an example network environment such as network portion 103 shown in FIG. 1, an embodiment of the present invention may therefore involve the network's control plane manager or controller that is aware of the location of the network's entire video contents and selecting the best location for every requested streaming, which could be either a video streaming server or an already existing STB. In the latter case, the controller may be configured to identify STBs with the same content, calculate the SLA parameters for every such STB to stream that content to the new customer/STB and estimate the impact of such action, which could be the amount of storage needed (e.g., instead of purging the already played content for local subscriber, the STB would keep that content for a longer period of time in order to stream it to a remote subscriber also), uplink throughput required, etc. One skilled in the art will recognize that in this scenario the control plane may have to constantly monitor the streaming characteristics and modify them, including changing the streaming source from a current STB to another STB or streaming server, when needed. As set forth above, one example implementation of such interactions between control plane functionality and STBs may be based on south-bound SDN protocols that can be suitably modified or extended to support streaming use case scenarios contemplated herein.

Further, the overall control plane functionality to achieve the foregoing objects may be configured to be broadly applicable to a network of pSTBs, vSTBs, and/or a combination thereof. In addition, the various interconnection architectures set forth in the present patent application may also be applied to STB scenarios having pSTBs, vSTBs or a combination thereof in a hybrid arrangement. Accordingly, the teachings and detailed description provided in the present patent application with respect to a particular interconnection scenario involving one type of STBs may be also applied to additional or alternative scenarios involving other types of STBs, mutatis mutandis. Accordingly, the term “STB” can refer to a range of STBs functionalities as previously described unless specifically limited to a particular type of arrangement.

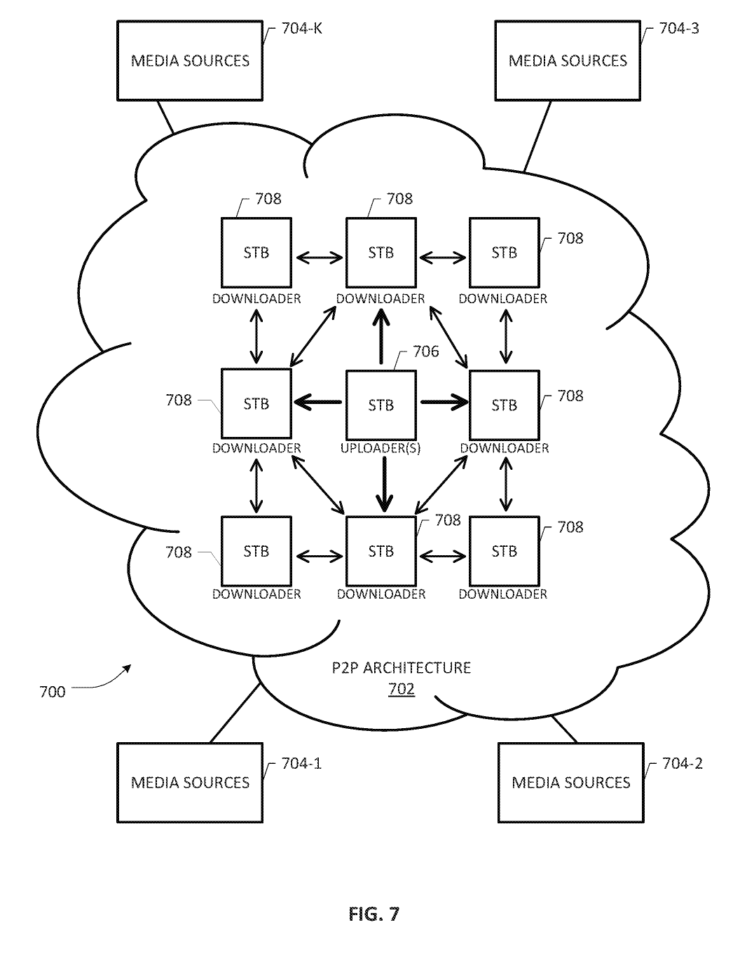

FIG. 7 depicts an example streaming networking environment 700 having a peer-to-peer (P2P) interconnection architecture 702 for connecting a plurality of STB nodes 706, 708 according to one embodiment. In one implementation, an existing P2P infrastructure may be modified for interconnecting the STB nodes of a video service operator network. In another implementation, a custom-built P2P infrastructure may be utilized. Regardless of how an example P2P infrastructure 702 is implemented, the STB nodes may be provided with suitable P2P software or program modules that can facilitate location, distribution and sharing of desired content within the video service operator network, wherein the STB nodes may be interconnected using a public network (e.g., the Internet). In another variation, a private P2P infrastructure may allow only mutually trusted peers to participate, which can be achieved by using a central server or other control plane functionality to authenticate client STB nodes. In a still further variation, the STB nodes may establish each other's presence and exchange passwords or tokens for ad hoc trust relationships. As one skilled in the art will recognize, seeding and leeching are two activities that can impact a P2P sharing architecture for sharing media assets among the STBs. In a torrent-based distribution scenario, for example, a torrent file is a computer file that contains metadata about files and folders to be distributed, and sometimes a list of network locations of tracker entities that help participants find each other and form efficient distribution groups, referred to as swarms. As such, a torrent file does not contain the content to be distributed; rather it only contains information about the content files, such as their names/locations, sizes, folder structure, and any cryptographic hash values for verifying file integrity. A seed is a complete copy of a file from which other users can download. A single torrent can have multiple seeds, allowing downloaders to obtain pieces from different sources and increasing total speed. Leechers can be entities that only download but not upload, thereby impacting the overall speed of the network. In certain contexts, leecher entities can also be entities that do not yet have the complete file, regardless of the download/upload speeds, and which may eventually become seeders.

In the context of content sharing among the STBs, a local STB may build its playing buffer (required for smooth uninterrupted streaming) using P2P requests to other STBs serving as seeders and eventually peers. Accordingly, in one implementation, the object is to create a large network of seeders to increase probability of getting desired content from one of such seeders versus obtaining content from a central streaming server associated with media sources (e.g., media sources 704-1 to 704-K illustrated in FIG. 7). However, it should be appreciated that in a general case a central streaming server may be operative as one of the seeders at least initially. Whereas the seeder population may increase rapidly in certain scenarios, overall status of the STB nodes can be very dynamic, because some STBs could change their status to be leechers or even unavailable for various reasons. Regardless of such dynamic (re)configuration of the status of the STBs, the P2P architecture can advantageously support the capability to obtain different content segments from different STB sources simultaneously. Moreover, it can also allow for obtaining future segments (from the local STB point of view) from other STBs currently playing or storing these segments, thereby minimizing or avoiding the need for extra buffering at the remote STBs.

By way of illustration, the P2P architecture 702 exemplifies one or more uploader STBs 706, where an uploader is the initial remote STB with the required or requested content. One or more downloader STBs 708 are operative to obtain the requested content from either directly from the uploader STBs 706 or from other peer STBs that already have the content segments being sought by the requesting STB. An example implementation of the P2P architecture 702 (which may be disposed at a data center in a virtualized STB environment, or involve interconnected pSTBs, or a combination of both vSTBs and pSTBs, as noted previously), one or more P2P protocols including but not limited to, e.g., BitTorrent protocol, BitCoin protocol, DirectConnect protocol, Ares protocol, FastTrack protocol, Gnutella protocol, OpenNap protocol, eDonkey protocol, and Rshare protocol, and the like, may be utilized for facilitating content file sharing.

A skilled artisan will recognize that there can be several implementations or mechanisms for facilitating STB interconnectivity and content sharing based on a P2P architecture set forth above. For example, a scenario may involve an internal multicast network where an uploader STB is configured as the multicast tree root, distributing the content to the rest of the network built using applicable multicast subscription mechanisms.

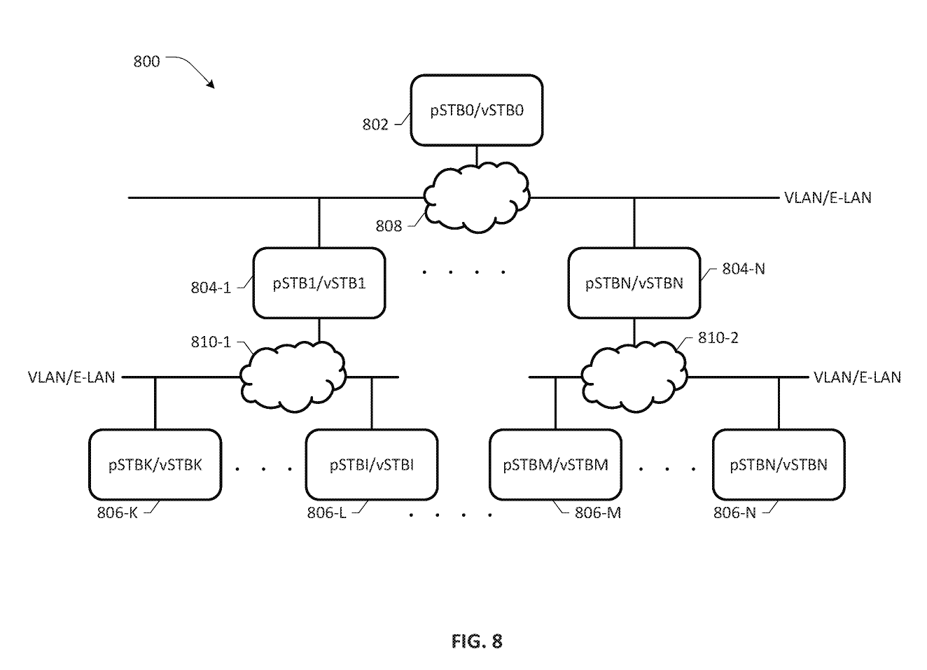

Another example STB interconnection embodiment involves a hierarchical interconnection architecture 800 depicted in FIG. 8, wherein a plurality of STB nodes may be interconnected in multiple hierarchical levels that may be coupled using several known or heretofore unknown connection technologies. A top level STB node 802 may be connected to a group of STBs 804-1 to 804-N using a connection network 808 such as Ethernet virtual private LAN (EVP-LAN or E-LAN) or virtual private LAN service (VPLS). Likewise, a group of STBs 806-K to 806-L and another group of STBs 806-M to 806-N disposed at additional levels may be interconnected via different E-LAN/VPLS 810-1, 810-2 to one or more STBs 904-1/904-N connected to the top level STB 902. As one skilled in the art will recognize, an example E-LAN may be provided as a multipoint-to-multipoint Ethernet virtual connection defined by the Metro Ethernet Forum as a carrier level Ethernet. An example VPLS/VLAN may involve extending an Ethernet broadcast domain to several geographically dispersed nodes over an IP or MPLS network (i.e., using pseudo wires). Other types of carrier Ethernet networking such as, e.g., E-Line, E-Tree, etc., as well as architectures such as Ethernet VPN or EVPN, Layer-2 VPN (L2VPN), Layer-3 VPN (L3VPN), etc. may also be used for inter- and intra-level connectivity of the STBs set forth in the architecture 800.

It should be appreciated that the foregoing interconnection architectures for STBs can achieve higher availability of requested content than when a centralized streaming server system (usually associated with a media service provider) is utilized as is currently done today, where there is always a chance to be disconnected and/or overloaded. Moreover, STB virtualization can significantly improve the overall system behavior. For instance, vSTBs of the present invention may be hosted by high-end servers running in very high throughput data center networks, which could be several thousand times of the order of magnitude compared to typical subscriber premises connectivity. Second, latency between vSTBs running on data center servers is typically much lower than latency between physical STBs at homes. Also, the content between vSTBs may be transferred in much larger chunks (e.g., using jumbo frames), which allows higher overall transfer rates. When vSTBs are hosted on the same server, they can use various shared memory technologies to avoid any extra data transfer. Additionally, instead of communicating with centralized media streaming servers via a single physical STB for a subscriber, multiple vSTBs may be launched or instantiated, each for a separate content stream or even a chunk of a particular content stream, where smart adaptive control can co-locate vSTBs that use the same streaming content to achieve the foregoing benefits.

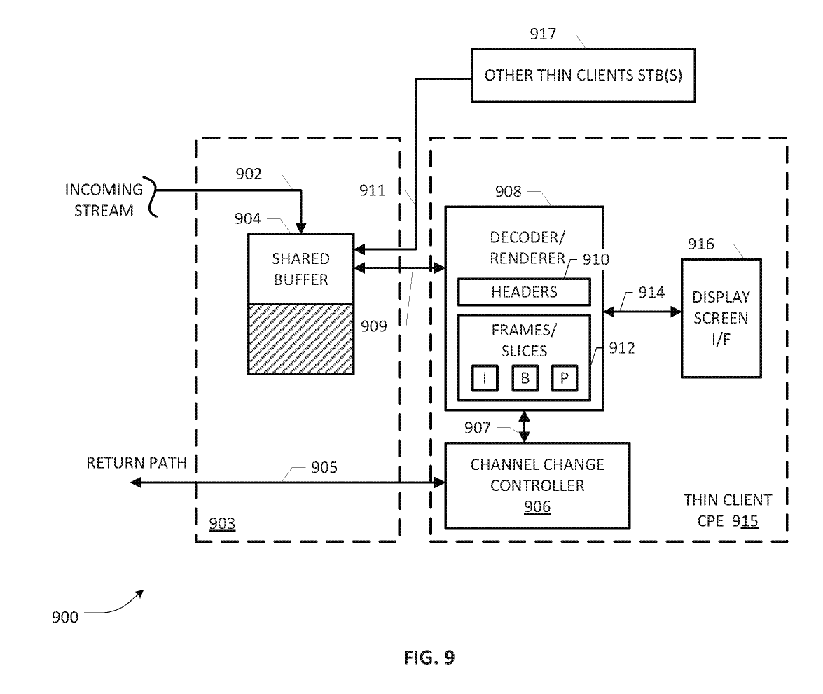

FIG. 9 depicts an example shared buffer scenario wherein a plurality of STBs may be configured to access a common stream according to one embodiment. As illustrated, an incoming stream 902 may be buffered in a shared buffer 904 (e.g., at a data center), which may be associated with one or more vSTBs (e.g., vSTB 903) or provided as a standalone shared resource. A thin client STB or CPE 915 including a decoder/renderer 908 is operative to receive a copy of the content stream via path 909 (e.g., responsive to a channel change control signal effectuated via a return path 905 to the control plane generated at a channel change controller 906). Example decoded data is illustratively shown as header data 910 and I/B/P frames or slices 912 (I-frames (Intra-coded pictures), B-frames (Bi-predictive pictures), or P-frames (Predictive pictures), which may be provided to a display screen interface 916 for display or playback. Other thin client STBs/CPEs 917 (which may belong to the same subscriber premises or associated with different subscribers) may also receive copies of the same content stream via respective media paths 911 responsive to interactions with their respective vSTBs having access to the shared buffer resource 904 of the data center.

As one skilled in the art will recognize, return channel signaling from the thin client STBs may go through respective vSTBs, after which it uses the existing infrastructure for effectuating control plane interactions. Depending on network implementation, return channel requests (e.g., channel change commands by end users) may be provided or received from STBs via a quadrature phase shift keying (QPSK) or via a return channel network in a DOCSIS/CMTS. In other implementations may involve out-of-band (OOB) signals via the return path in a DAVIC arrangement based on SCTE 55-1 and SCTE 55-2, wherein the OOB signals may be used for one-way and/or two-way communications with the STBs. Where a separate DOCSIS return path is not provided, control signaling for two-way communication may be effectuated using a suitable network controller and/or cable card architecture.

Whereas the implementation shown in FIG. 9 is particularly exemplified with thin clients sharing a buffer, it should be clear that even pSTBs may be configured to use a shared buffer such as, e.g., buffer 904, for a subset of contents while using local private storage for other content in certain additional or alternative embodiments.

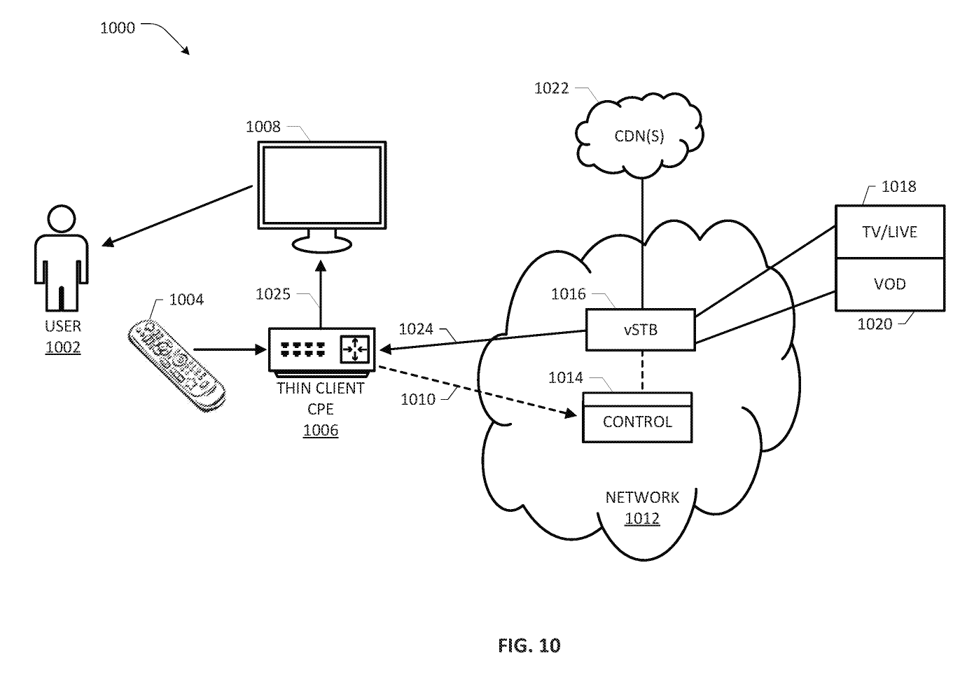

FIG. 10 illustrates an example user interaction scenario 1000 for consuming content using a vSTB implementation according to one embodiment. When a subscriber 1002 inputs a channel control command (e.g., via a remote control 1004) with respect to a content program, it is propagated to a thin client STB/CPE 1006, from which is transmitted via suitable control plane communication path 1010 to a control plane entity 1014 of the video service provider network 1012. Upon interactions between the control plane entity 1014 and subscriber's vSTB 1016, appropriate content source is located, which could be another vSTB or a media server associated with a TV/live program source 1018 or VOD 1020 (for on-net content), or an external content source such as a CDN 1022 (for off-net content). As will be seen below, locating the requested content may involve vSTB optimization, taking into account such factors as network/bandwidth conditions, routing delays/latencies, any signal conversion being required (e.g., IP to RF via QAM), segment processing (e.g., transcoding of bitrates as needed), etc. Thereafter, frames of the requested content data (potentially, appropriately processed) are transmitted to the requesting thin client STB 1006 via a suitable downstream network path 1024. As noted above, the thin client STB 1006 decodes and processes the received packets for rendering at a display device 1008.

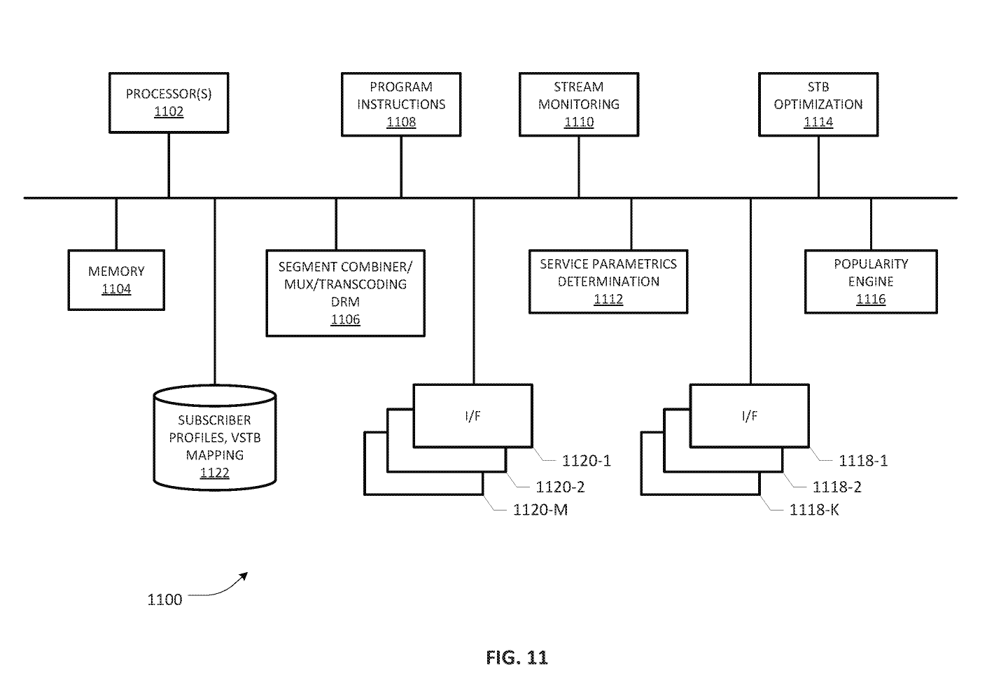

Turning to FIG. 11, depicted therein is a block diagram of an example computer-implemented system or subsystem 1100 at least parts of which may be configured or reconfigured in different ways to operate as an apparatus, node, subsystem or element operative in a network implementation of the present invention. For example, subsystem 1100 may be configured as a control plane manager, vSTB/pSTB controller, one or more distributed content popularity determination engines or nodes, upstream content stream processing entities, and the like, operating in the control and/or data domains of the network according to an embodiment of the present patent application One or more processors 1102 may be coupled to memory 1104 and persistent memory 1108 for executing various program instructions or modules with respect to one or more processes set forth herein. A segment combiner/(re)mux and/or transcoder module 1106 may be configured to process a content stream or a copy thereof located responsive to a subscriber request based on, e.g., the requesting device characteristics and capabilities, including connected display characteristics such as display device resolutions, manufacturer name and serial number, product type, phosphor or filter type, timings supported by the display, display size, luminance and pixel mapping data, among others. A database structure 1122 is operative for storing subscriber/device profiles, vSTB mappings, service policies, DRM compliance and authentication policies, and the like. Various interfaces (I/F) 1120-1 to 1120-M are representative of network interfaces that the apparatus 1100 may use for downstream communications whereas I/Fs 1118-1 to 1118-K are operative with respect to upstream communications (i.e., to other network nodes at a higher level in the hierarchical network architecture). A stream monitoring module 1110 is operative to monitor and maintain status of all content requests, streams being currently consumed, pending requests, as well as where and what stage the content streams are within the entire video streaming network infrastructure. An STB optimization module 1114 is operative for selecting optimal location(s) of requested content streams responsive to media requests received from the subscriber devices (e.g., thin client STBs, thick client STBs, etc.). A module 1112 is operative for calculating SLA parameters for streaming content from one or more STBs identified as having copies of requested content, including estimates of the impact of different streaming scenarios (e.g., respective latencies associated with streaming from different STB locations to a particular requesting STB), which may be provided as an input to the STB optimization module 1114. A content popularity engine 1116 may also be provided in certain embodiments for monitoring download patterns of various content that is being shared among different STBs and determine popularity-based metrics accordingly in different interconnection architectures.

One skilled in the art should recognize that the apparatus 1100 described above may be (re)configured to operate in various STB interconnection architectures set forth hereinabove. Accordingly, at least some of the modules and blocks may be rearranged, modified or omitted in a particular embodiment while the program instructions stored in persistent memory 1108 may also be suitably configured or reconfigured for executing appropriate service logic relevant to the particular embodiment(s) depending on implementation.

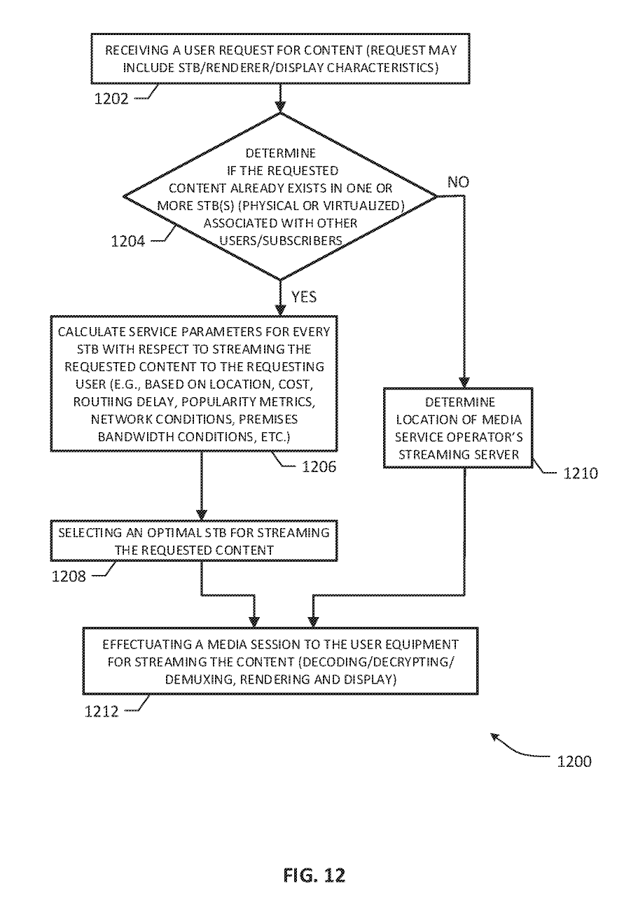

FIG. 12 depicts a flowchart of steps, acts, blocks and/or functions that may take place as part of a process 1200 at a network element (e.g., apparatus 1100 in one example configuration) for effectuating content consumption in a network environment of the present invention. At block 1200, a user request for content may be received at a network node (the request may include STB/renderer/display characteristics and capabilities, as well as local network conditions relative to the CPE device generating the request in some embodiments). A determination is made if the requested content already exists in one or more STB(s) (physical or virtualized) associated with other users/subscribers of the video streaming service provider (block 1204). If so, appropriate service parameters for every STB with respect to streaming the requested content to the requesting user may be calculated as set forth at block 1206 (e.g., based on location, cost, routing delay, popularity metrics, end-to-end network conditions, premises bandwidth conditions, device characteristics, etc.). Thereafter, an optimal STB may be selected (block 1208) for streaming the requested content (e.g., based on various selection criteria involving performance, impact on resources, compute times, latencies, etc.) as well as operator policies, subscriber policies, content owner's policies, etc. On the other hand, if no other STB(s) already contain the requested content, optimal location of video service operator's streaming server(s) may be determined (block 1210). Once an optimal STB or the operator's media streaming server is located and selected, a media session to the STB or associated user equipment may be effectuated for streaming the content, whereupon appropriate processing (decoding/decrypting/demuxing, rendering and display) may take place (block 1212). One skilled in the art will recognize that in some alternative embodiments, STB optimization may involve taking into account both available STBs having copies of the requested content as well as video service operator's media streaming servers to determine an optimal site from which to stream. In such a scenario, even if a plurality of STBs may already have copies of the requested content, the service logic may end up selecting the operator's media streaming server because of, e.g., a determination that a more optimal delivery may be made by not using the STBs.

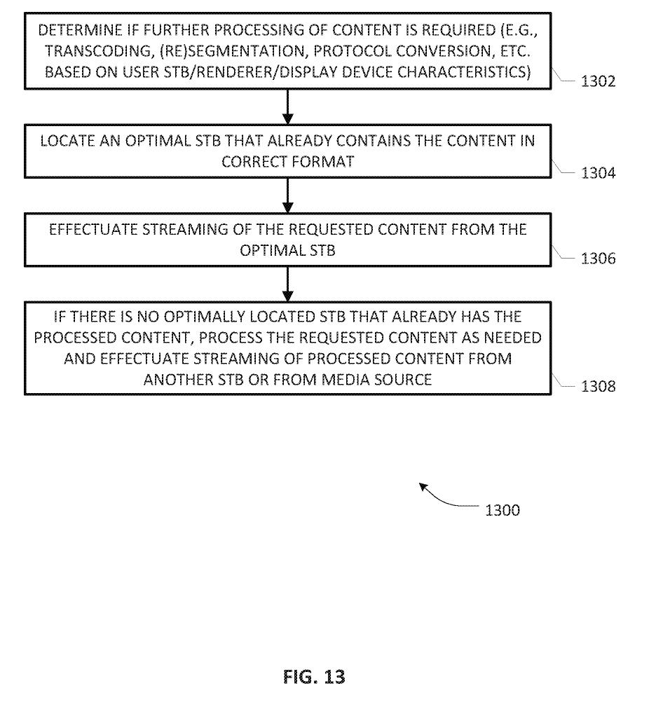

FIG. 13 depicts a flowchart of additional/alternative steps, acts, blocks and/or functions that may take place as part of a process 1300 in combination or sub-combination with the foregoing process according to additional/alternative embodiments. At block 1302, a determination may be if any further processing of a requested content stream is required (e.g., (re)segmentation, transcoding of content, conversion of protocols, formats or containerization schemes (for instance, from HLS to MPEG-DASH or vice versa) based on client streaming player capabilities and STB/renderer/display device characteristics). At block 1304, an optimal STB that already contains the processed content is located, whereupon such content is streamed therefrom to the requesting CPE (block 1306). If there is no optimally located STB that already has the processed content, the requested content may be processed as needed and streamed from another STB or from the media source as set forth at block 1308. Where an optimization takes place after accounting for the content processing first (e.g., multiple STBs may be available and/or operative to process the content as needed, but only one is optimally located), an optimal STB may also be identified accordingly. It should be recognized that blocks, steps, and acts of processes 1200 and 1300 may be combined in a number of permutations and combinations, thereby yielding additional or alternative schemes involving STB optimization and selection of a suitable STB (or a video service operator's streaming server in some cases). For instance, a further embodiment may comprise determining if there is no vSTB already supporting the requested particular content, mapping streaming from a central media server into at least one of an existing and a newly instantiated vSTB and optionally storing the particular content at the newly instantiated vSTB as determined by the control plane manager.

In view of the foregoing discussion, it should be readily apparent that logically interconnected STBs can significantly improve end-user experience. However, local decision of content sharing from another STB and/or using a shared content storage may present some challenges in traditional content popularity determination schemes, which are usually executed at a central location based on monitoring streaming requests from the central streaming server(s). Clearly, such schemes will not be able to accurately assess popularity of content that may be locally “sourced” (at least for the most part) based on dynamically changing STB interconnection scenarios and accompanying variable STB optimization schemes, especially with respect to vSTBs interconnected by a partial or full logical mesh architecture. Set forth below are embodiments of several architectural mechanisms for addressing the aforementioned issues.

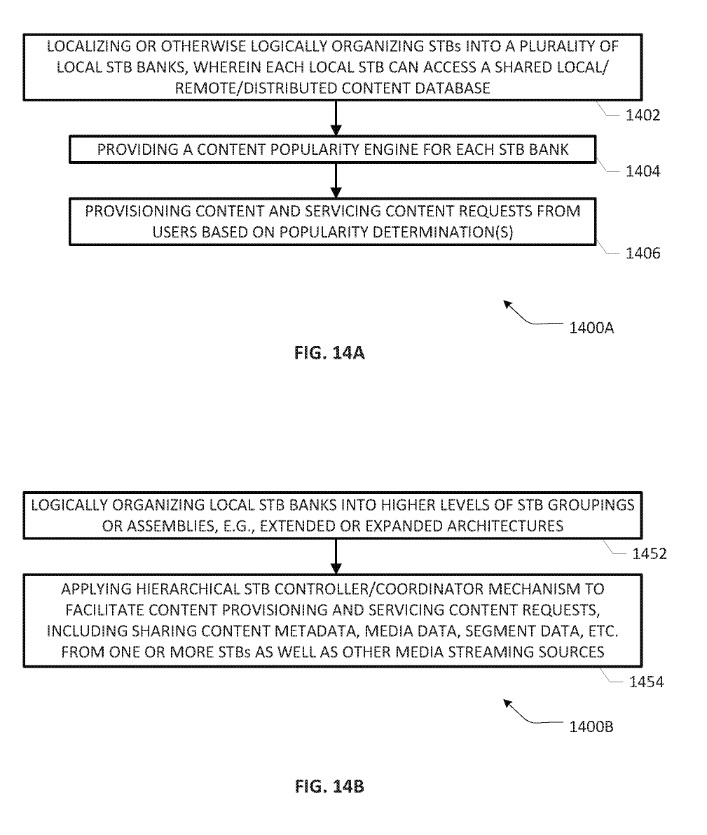

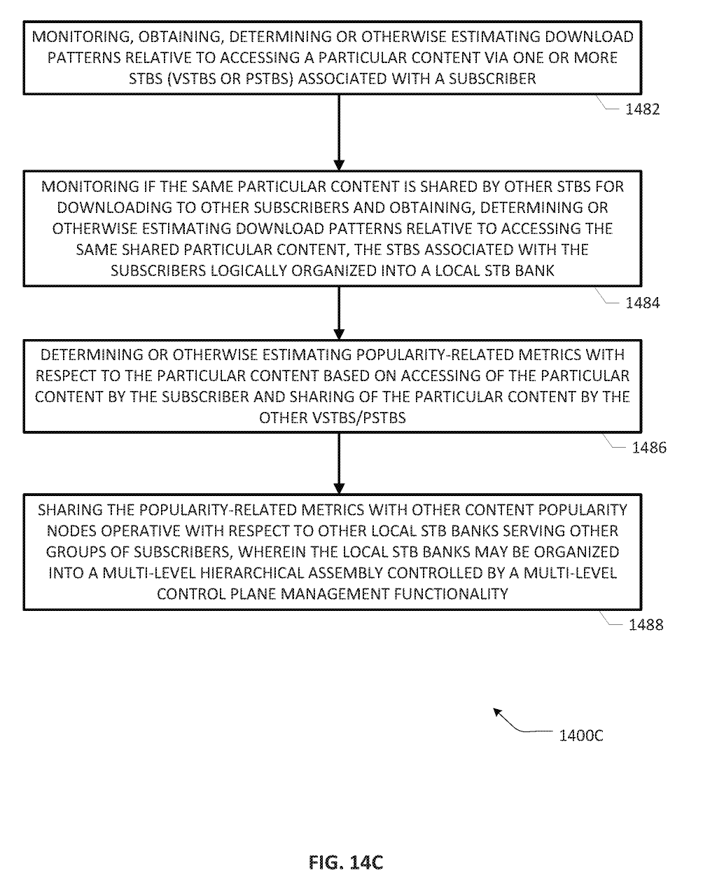

Turning to FIGS. 14A-14C in particular, depicted therein are various additional processes that may be effectuated for providing popularity-based analytics in an interconnected STB environment according to one or more embodiments of the present patent disclosure. At block 1402 of example process 1400A, a plurality of STBs of a video service operator network may be localized, clustered or logically organized into one or more local STB banks, as will be set forth in additional detail hereinbelow, wherein each local STB can access a shared content database, which may be disposed at one or more levels of a hierarchically distributed database structure or system (e.g., local, remote, or distributed content database). In one implementation, a vSTB/pSTB controller facilitating the control plane functionality localized with respect to the local STB bank may be configured for each local STB bank. Further, a content popularity engine is also provided for each local STB bank, preferably operating in association with the local STB controller (block 1404). Thereafter, content may be provisioned (based on future popularity estimates or determination, for example) and content requests from local STB users may be serviced accordingly (block 1406).

In a still further variation, additional layers of logical organization of STBs may be implemented as extended or expanded STB banks as set forth in example process 1400B. At block 1452, two or more local STB banks may be interconnected, each having its own respective STB controller and popularity engine. At a still higher level of organization, groups of two or more of such interconnected local STB banks may be logically interconnected based on suitable parametric clustering. STB controllers of each level may be configured to be inter-operative with STB controllers of adjacent level (i.e., higher level controllers or lower level controllers). It should be appreciated that successive levels of STB controllers together operate as a hierarchically organized control plane management mechanism for the entire assemblages of the STBs, along with hierarchically distributed popularity determination nodes. Accordingly, such a hierarchical STB controller/coordinator mechanism is applied for gathering statistics at different levels of STBs to obtain better, more fine-tuned, popularity determinations based on sharing of the content streams, as well as for facilitating content provisioning and servicing content requests, including sharing content metadata, media data, segment data, etc. from one or more STBs or other media streaming sources, as set forth at block 1454.

A skilled artisan will further recognize that by grouping the STBs in such logically organized “local clusters” as set forth above (not necessarily based on geo-location or physical proximity), a set of STBs having certain characteristics (e.g., the ease and access throughput available for STBs to share the content) may be more effectively monitored and managed at a finer granularity level. For example, in a virtualized STB scenario, several vSTBs executing within the same server can either use common shared memory for the content or, alternatively, service content requests between local vSTBs using very efficient in-server mechanisms such as, e.g., Smart NIC enabled data access and/or transfer, or any other mechanism providing high throughput and low latency access operations. Known technologies such as Storage Area Networking (SAN), Network Attached Storage (NAS), iSCSI, ATA over Ethernet (AoE), Infiniband or Fiber Channel based storage arrays, etc. may be advantageously employed within local STB banks. Further, with the advent of advanced technologies such as optically connected memory, logical boundaries between local and extended STB banks may be minimized or eliminated.

FIG. 14C depicts an example process 1400C associated with a content popularity determination system according to an embodiment of the present invention. At block 1482, a network functionality is provided for monitoring, obtaining, determining or otherwise estimating download patterns relative to accessing a particular content via one or more STBs (vSTBs/pSTBs) associated with a subscriber. The network functionality is further operative for monitoring if the same particular content is shared by other STBs for downloading to other subscribers. Download patterns relative to accessing the same shared particular content by the other STBs are also obtained, determined or otherwise estimated, set forth at block 1484. As noted above, the STBs associated with the subscribers may be logically organized into a local STB bank. Responsive to the monitoring operations, popularity-related metrics with respect to the particular content based on accessing of the particular content by the subscriber and sharing of the particular content by the other vSTBs/pSTBs may be determined or otherwise estimated (block 1486). It should be noted that this popularity estimation may be deemed as a current or real-time or near real-time popularity determination since it is concerned with ongoing content consumption, although such determinations may be augmented by taking into account any predictions of content popularity based on an number of factors and variables such as, e.g., content trending data in social media, content search data based on Internet searches, subscriber demographic data and content preference data, revenue/marketing data related to the content, etc. that may be provided or analyzed in a Big Data analytics system. The popularity-related metrics may be shared with other content popularity nodes operative with respect to other local STB banks serving other groups of subscribers, wherein the local STB banks may be organized into a multi-level hierarchical assembly controlled by a multi-level control plane management functionality, as noted previously (block 1488).

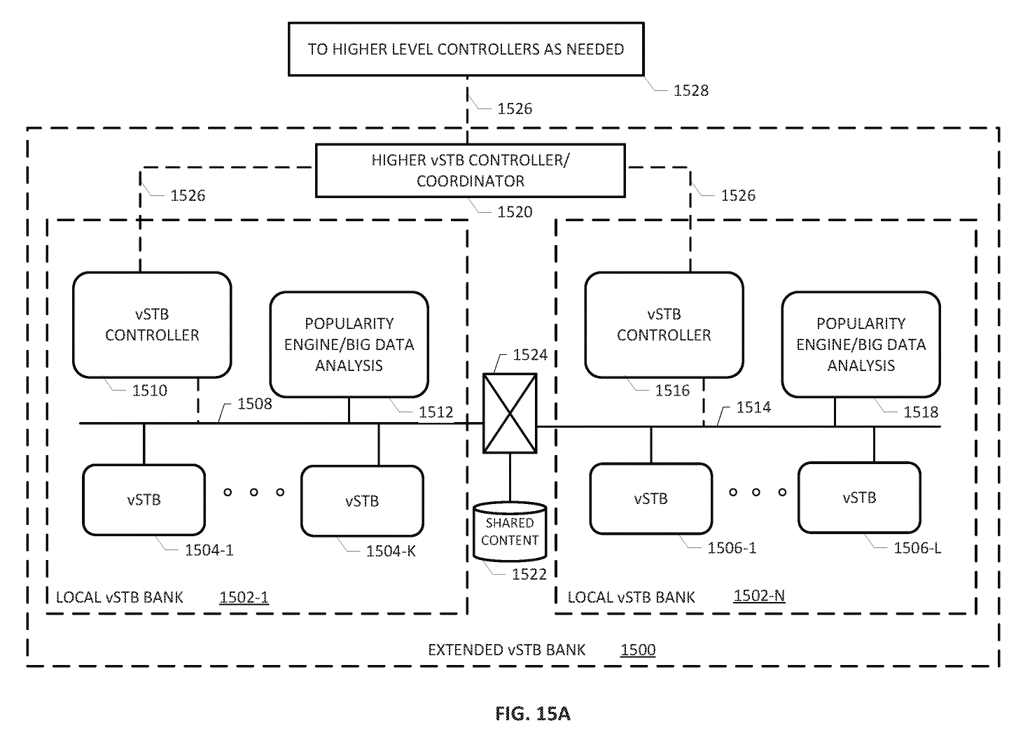

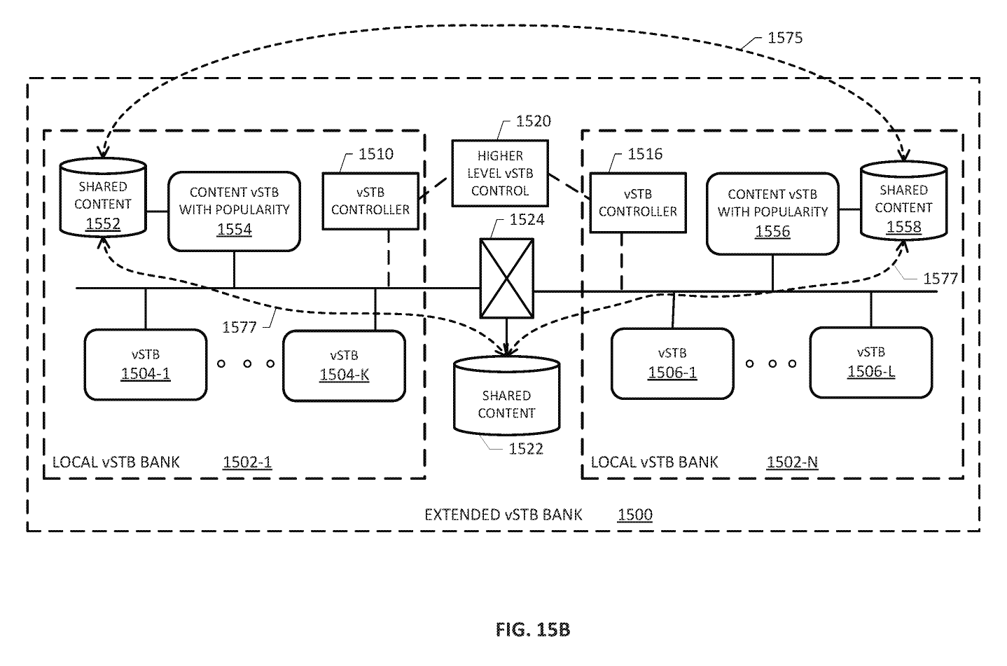

FIGS. 15A and 15B depict example vSTB localization/clustering architectures that may involve content popularity metrics for facilitating content consumption according to one or more embodiments. An example extended vSTB bank or assembly 1500 in FIG. 15A may include a number of local vSTB banks or clusters, e.g., a first local vSTB bank 1502-1 and a second local vSTB bank 1502-N, which may be coupled via a switching apparatus or network 1524. A first plurality of vSTBs 1504-1 to 1504-K are logically clustered and organized via an interconnection mechanism 1508 as cluster 1502-1 (e.g., a first subset), which may be controlled by a local vSTB controller 1510. In one example implementation, each local vSTB cluster 1502-1, 1502-N may be hosted on a corresponding server or set of servers. Also provided as part of local vSTB cluster 1502-1 is a local popularity determination engine 1512 that may be interfaced to or otherwise associated with a suitable Big Data analytics platform. In similar fashion, local vSTB bank or cluster 1502-N includes a second plurality of vSTBs 1506-1 to 1506-L (a second or Nth subset) that are logically interconnected using an interconnection mechanism 1514, e.g., similar to an interconnection architecture described above. A local vSTB controller 1516 is operative for controlling control plane management operations with respect to the second local vSTB bank 1502-N, which also includes a local popularity determination engine 1518. As illustrated in FIG. 15A, local vSTB controllers 1510, 1516 may be interfaced together via a higher level vSTB controller or coordinator 1520 via suitable control paths 1526 for managing the control plane operations relative to the overall extended vSTB bank assembly 1500. Further, the higher vSTB controller/coordinator 1520 may also be interfaced with additional higher level vSTB controllers 1528 via control paths 1526, as will be exemplified in further embodiments below.

As previously noted, localization or clustering of vSTBs into separate local banks is not necessarily defined by geographical localities; rather, such clustering may be based on a number of factors such as, e.g., similar network performance characteristics, subscriber demographics, historical content delivery patterns, and the like. An embodiment of the smart control plane architecture of the present invention is preferably operative to use multi-factorial parameterization analytics to determine which sets of STBs may be logically interconnected and organized as a local vSTB cluster. Clearly, factors such as inter-vSTB latencies less than specified thresholds, network throughputs greater than specified thresholds, etc. may be considered in logically organizing a vSTB cluster. The smart control plane architecture also allows for the vSTB controllers to be aware of which content streams are being requested, when and where they are (will be) available and how many copies, how fresh the content at the various locations is, etc.

In one example implementation, a popularity engine of the present invention may be provided as a logical entity that may be realized as an independent software or hardware element. However, it may also be configured as an integrated mechanism for collecting statistics within the vSTB or protocol being used with respect to a local cluster. For instance, in a P2P interconnection architecture, it is possible to utilize a suitable P2P protocol to generate and expose content availability, content access and other related statistics. In a further example, a SW-based dedicated content popularity element may be implemented as a special Content vSTB that does not serve any user, but just holds the content for all other vSTBs within the local vSTB bank while maintaining the popularity statistics in that special Content vSTB. Clearly, the present disclosure is not limited to such an implementation only; rather numerous other scenarios and implementations of content/popularity integration (or, distribution, as the case maybe) may be provided for practicing an embodiment hereof, for example, involving content sharing between different local storage entities.

Referring now to FIG. 15B, shown therein is another embodiment of the extended vSTB bank 1500 having content distribution paths between the local vSTB banks 1502-1, 1502-N, either directly or via the shared content database 1522 within the extended vSTB bank 1500. Each local vSTB bank 1502-1, 1502-N is also provided with a respective content vSTB with popularity node 1554, 1556, which may be interfaced to or otherwise integrated with suitable Big Data analytics platforms as mentioned above. Additionally, each local content vSTB with popularity node 1554, 1556 is provided with a corresponding local shared content database 1552, 1558. As illustrated, a local shared content database may share or access data from another local shared content database (as represented by a data share path 1575) or from the shared database 1522 serving multiple vSTB clusters, i.e., the extended vSTB bank 1500 (as represented by data share path 1577).

It should be appreciated that an implementation of one or more embodiments set forth in the present disclosure may be configured such that the shared data between the local vSTB banks can be just metadata (e.g., location pointers, header information, etc.) rather than the actual media data itself (for instance, in scenarios when the content can be accessed remotely). In additional variations, sharing the data can be performed at different stages of various playback scenarios, e.g., for facilitating content start (partial local storage with limited content information for initial streaming to confirm the user interest), under the assumption that the rest of the content could be brought into the local storage faster than the initial content playback time (e.g., due to improved network conditions). Also, amount of the content cached locally may depend on the difference of time between the cache playback time and the next cache download time), or the entire content.

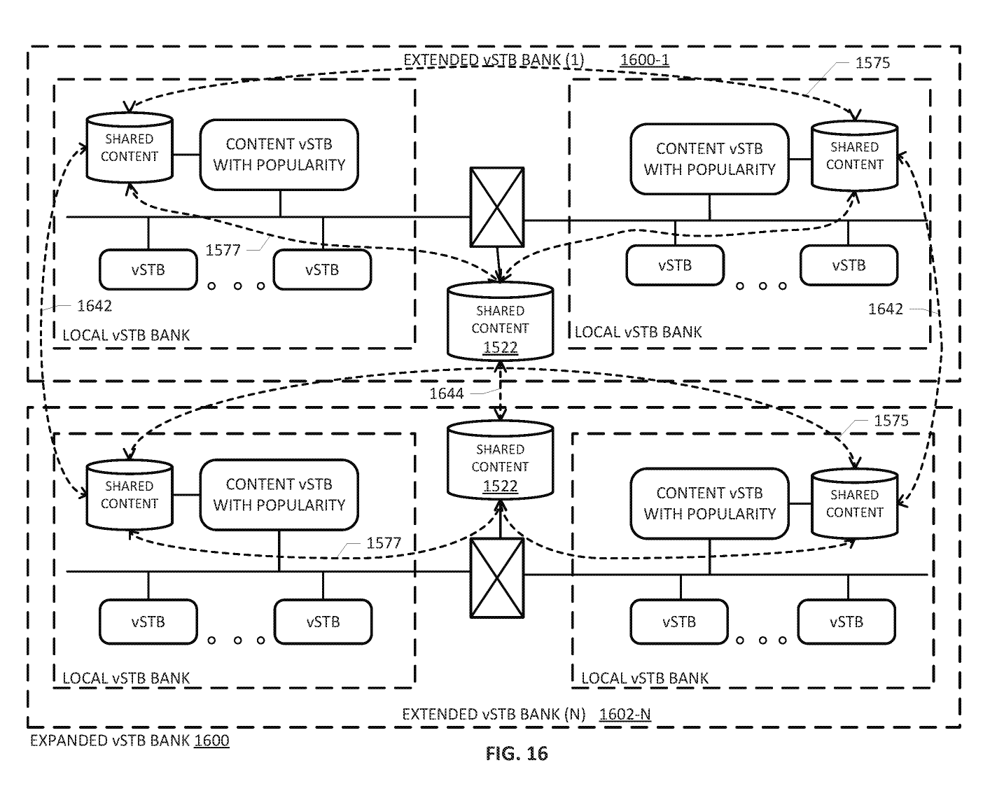

FIG. 16 depicts an example hierarchical localization/clustering architecture involving multiple local/extended STB banks and shared/distributed or localized content database(s) according to an embodiment. By way of illustration, a plurality of extended vSTB banks 1602-1, 1602-N are interoperatively coupled to form another higher organizational level of vSTBs, referred to here in as an expanded vSTB assembly 1600. Similar to the embodiments set forth above, each extended vSTB bank 1602-1, 1602-N, may include a variable number of local vSTB clusters, each local vSTB cluster comprising a corresponding number of vSTBs, each local vSTB cluster being hosted by a corresponding server or group of servers. In addition to the data share paths 1575 and 1577 within the extended vSTB bank 1602-1, 1602-N, local shared content databases may now share or access data from across different extended vSTB banks 1602-N, as exemplified by data share paths 1642. Furthermore, at a higher level of data sharing, content databases 1522 from different extended vSTB banks may be shared via suitable data share paths 1644. Although not specifically shown in FIG. 16, it should be clear that one or more extended vSTB banks 1602-1, 1602-N of the expanded vSTB assembly 1600 may include local vSTB controllers and interfacing with higher level control plane management functionalities as previously described.

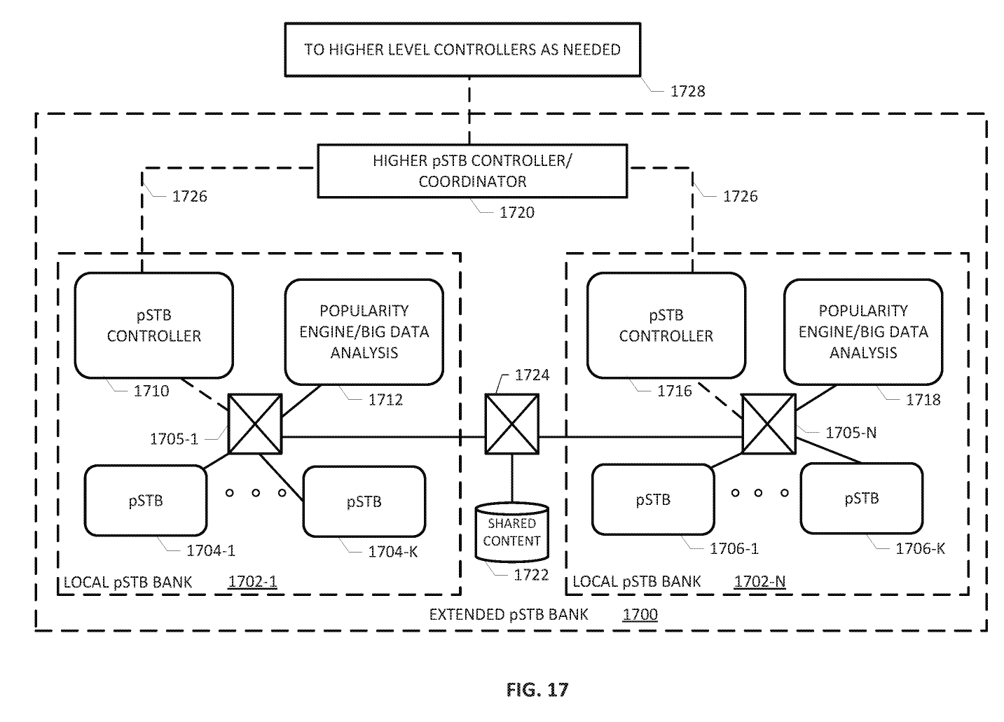

FIG. 17 depicts an example thick-client STB or pSTB localization/clustering architecture involving content popularity analytics in an interconnected STB environment according to an embodiment of the present patent disclosure. One skilled in the art will recognize that this and other similar distributed content popularity architectures for pSTB or hybrid STB implementations may be realized analogous to the foregoing vSTB-based architectures, whose description may be applied here as well, mutatis mutandis. Accordingly, comparable to the local vSTB clusters 1502-1, 1502-N, a plurality of pSTB clusters or sets 1702-1, 1702-N, may be defined although such pSTBs may be disposed in different subscriber premises. By way of illustration, STBs 1704-1 to 1704-K are logically organized and interconnected using a local network 1705-1, forming a first local STB cluster set 1702-1. Likewise, STBs 1706-1 to 1706-K are logically organized and interconnected using a local network 1705-N that forms a second local STB cluster set 1702-N. An extended STB set 1700 may be defined as a next hierarchical level of organization that interconnects the local STB cluster sets 1702-1, 1702-N via a network 1724. Similar to the vSTB architecture of FIG. 15A, each local STB cluster 1702-1, 1702-N is provided with a local STB controller 1710, 1716, and a local popularity determination engine 1712, 1718. A higher level STB controller/coordinator 1720 is operative for facilitating inter-local STB cluster control plane communications as well as control plane communications with higher level controllers 1728 as described previously.

One of ordinary skill in the art will recognize that in the foregoing embodiments, a content popularity engine may be configured, responsive to monitoring of various content streams in the network, to collect all the required statistics to facilitate a determination as to whether the content can be stored remotely, partially locally, or fully locally. Furthermore, the teachings of the present disclosure may be practiced in an embodiment that allows for a hybrid deployment scenario, wherein part of the content popularity is served by the distributed popularity engines set forth herein, and part of the deployment is served by traditional, centrally based popularity nodes. In such an implementation, a popularity engine could be responsible for popularity information sharing between these two entities—distributed nodes and legacy nodes, potentially managed by different service operators.

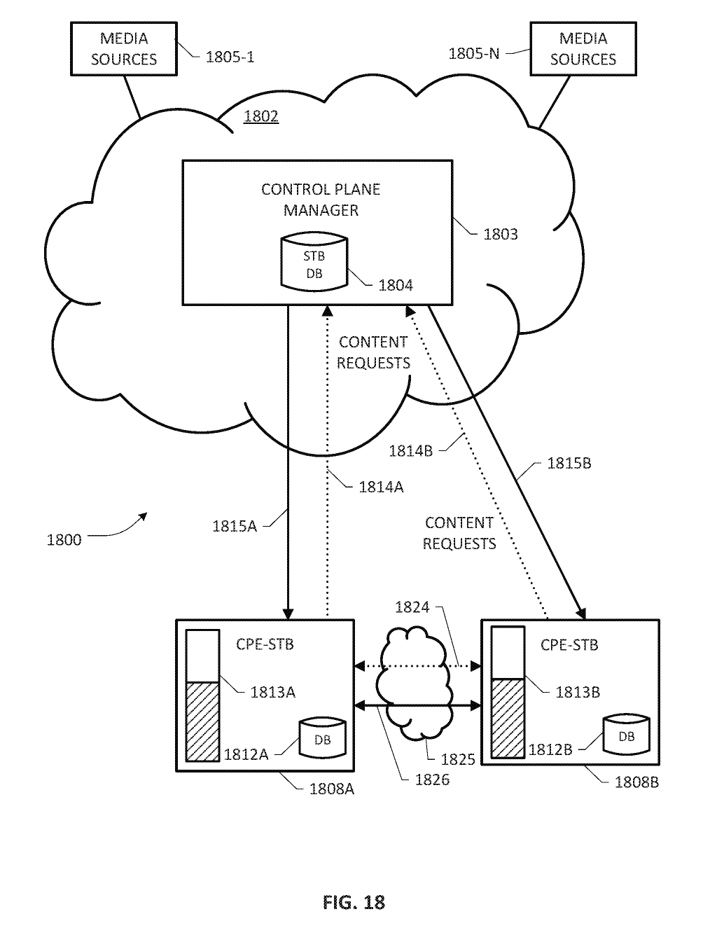

FIG. 18 depicts an example network environment 1800 wherein thick-client STBs or pSTBs are operative to interact with one another for sharing content according to an embodiment. A network 1802 having a control plane manager 1803 and coupled to a plurality of media sources 1805-1, 1805-N is exemplary of the network portion 103 set forth in FIG. 1. STBs 1808A, 1808B may be embodied as a thick client STB such as STB 300 of FIG. 3, and may be disposed in a subscriber premises (e.g., premises 202 of FIG. 2) or at different geographical locations interconnected via a network portion 1825. As illustrated, the control plane manager 1803 includes or is otherwise associated with a subscriber and STB database 1804 for facilitating, inter alia, smart control plane functionality with respect to managing media content served via the network environment 1800. Each STB device 1808A, 1808B is operative to effectuate control channel commands to the control plane manager 1803 via respective control plane paths 1814A, 1814B to obtain media content. Further, each STB device 1808A, 1808B is provided with a respective media buffer 1813A, 1813B, as well as a local storage 1812A, 1812B, for storing downloaded media content. Responsive to a user request from an STB, e.g., STB 1808A, the control plane manager 1803 is operative to determine that the requested content is available at one or more STBs and one or more such STBs may be capable of sharing the requested content, and accordingly determine an optimal STB based on the techniques set forth hereinabove. After selecting the optimal STB, e.g., STB 1808B, a media session between STBs 1808A and 1808B may be effectuated via a data path 1826 of the network portion 1825 for receiving the requested content therefrom. As noted previously, part of the data may be downloaded from the optimal STB 1808B whereas the remainder may be downloaded from the media source(s) 1805-1, 1805-N, via download path 1815A that can be dynamically managed. In a further variation, the requesting STB 1808A may be provided with metadata from the network, the metadata referencing the media stored at STB 1808B. Upon receiving the metadata, the requesting STB 1808A may issue fragment requests to STB 1808B (e.g., as illustrated by request path 1824) to obtain the requested content from its local database 1812B.

The foregoing scenario may also be implemented where the remote STB, i.e., STB 1808B, is concurrently engaged in downloading the required content via download path 1815B from a media source. Even in such a scenario, the control plane manager 1803 may still determine that it is more efficient for STB 1808A to obtain the content (or part of the content) from STB 1808B rather than from a centralized media source (e.g., not having to consume the network resources for transmitting multiple copies of the same content). Accordingly, in this and other embodiments involving vSTBs and/or vSTB/pSTB hybrid environments, “content” can be either the entire media content, beginning of media content or just a part of the media content to be streamed now or in the future, even just the metadata thereof.

In the above-description of various embodiments of the present disclosure, it is to be understood that the terminology used herein is for the purpose of describing particular embodiments only and is not intended to be limiting of the invention. Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of this specification and the relevant art and may not be interpreted in an idealized or overly formal sense expressly so defined herein.

Furthermore, as noted previously, at least a portion of an example network architecture disclosed herein may be virtualized as set forth above and architected in a cloud-computing environment comprising a shared pool of configurable virtual resources. For instance, various pieces of software, e.g., content encoding schemes, DRMs, segmentation mechanisms, media asset package databases, etc., as well as platforms and infrastructure of a video service provider network may be implemented in a service-oriented architecture, e.g., Software as a Service (SaaS), Platform as a Service (PaaS), infrastructure as a Service (IaaS) etc., with multiple entities providing different features of an example embodiment of the present invention, wherein one or more layers of virtualized environments may be instantiated on commercial off the shelf (COTS) hardware. Skilled artisans will also appreciate that such a cloud-computing environment may comprise one or more of private clouds, public clouds, hybrid clouds, community clouds, distributed clouds, multiclouds and interclouds (e.g., “cloud of clouds”, and the like.

At least some example embodiments are described herein with reference to block diagrams and/or flowchart illustrations of computer-implemented methods, apparatus (systems and/or devices) and/or computer program products. It is understood that a block of the block diagrams and/or flowchart illustrations, and combinations of blocks in the block diagrams and/or flowchart illustrations, can be implemented by computer program instructions that are performed by one or more computer circuits. Such computer program instructions may be provided to a processor circuit of a general purpose computer circuit, special purpose computer circuit, and/or other programmable data processing circuit to produce a machine, so that the instructions, which execute via the processor of the computer and/or other programmable data processing apparatus, transform and control transistors, values stored in memory locations, and other hardware components within such circuitry to implement the functions/acts specified in the block diagrams and/or flowchart block or blocks, and thereby create means (functionality) and/or structure for implementing the functions/acts specified in the block diagrams and/or flowchart block(s). Additionally, the computer program instructions may also be stored in a tangible computer-readable medium that can direct a computer or other programmable data processing apparatus to function in a particular manner, such that the instructions stored in the computer-readable medium produce an article of manufacture including instructions which implement the functions/acts specified in the block diagrams and/or flowchart block or blocks.

As alluded to previously, tangible, non-transitory computer-readable medium may include an electronic, magnetic, optical, electromagnetic, or semiconductor data storage system, apparatus, or device. More specific examples of the computer-readable medium would include the following: a portable computer diskette, a random access memory (RAM) circuit, a read-only memory (ROM) circuit, an erasable programmable read-only memory (EPROM or Flash memory) circuit, a portable compact disc read-only memory (CD-ROM), and a portable digital video disc read-only memory (DVD/Blu-ray). The computer program instructions may also be loaded onto or otherwise downloaded to a computer and/or other programmable data processing apparatus to cause a series of operational steps to be performed on the computer and/or other programmable apparatus to produce a computer-implemented process. Accordingly, embodiments of the present invention may be embodied in hardware and/or in software (including firmware, resident software, micro-code, etc.) that runs on a processor or controller, which may collectively be referred to as “circuitry,” “a module” or variants thereof. Further, an example processing unit may include, by way of illustration, a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), and/or a state machine. As can be appreciated, an example processor unit may employ distributed processing in certain embodiments.

Further, in at least some additional or alternative implementations, the functions/acts described in the blocks may occur out of the order shown in the flowcharts. For example, two blocks shown in succession may in fact be executed substantially concurrently or the blocks may sometimes be executed in the reverse order, depending upon the functionality/acts involved. Moreover, the functionality of a given block of the flowcharts and/or block diagrams may be separated into multiple blocks and/or the functionality of two or more blocks of the flowcharts and/or block diagrams may be at least partially integrated. Furthermore, although some of the diagrams include arrows on communication paths to show a primary direction of communication, it is to be understood that communication may occur in the opposite direction relative to the depicted arrows. Finally, other blocks may be added/inserted between the blocks that are illustrated.

It should therefore be clearly understood that the order or sequence of the acts, steps, functions, components or blocks illustrated in any of the flowcharts depicted in the drawing Figures of the present disclosure may be modified, altered, replaced, customized or otherwise rearranged within a particular flowchart, including deletion or omission of a particular act, step, function, component or block. Moreover, the acts, steps, functions, components or blocks illustrated in a particular flowchart may be inter-mixed or otherwise inter-arranged or rearranged with the acts, steps, functions, components or blocks illustrated in another flowchart in order to effectuate additional variations, modifications and configurations with respect to one or more processes for purposes of practicing the teachings of the present patent disclosure.

Although various embodiments have been shown and described in detail, the claims are not limited to any particular embodiment or example. None of the above Detailed Description should be read as implying that any particular component, element, step, act, or function is essential such that it must be included in the scope of the claims. Reference to an element in the singular is not intended to mean “one and only one” unless explicitly so stated, but rather “one or more.” All structural and functional equivalents to the elements of the above-described embodiments that are known to those of ordinary skill in the art are expressly incorporated herein by reference and are intended to be encompassed by the present claims. Accordingly, those skilled in the art will recognize that the exemplary embodiments described herein can be practiced with various modifications and alterations within the spirit and scope of the claims appended below.

What is claimed is:

1. A data center configured to facilitate media streaming in a network environment, comprising:
a control plane manager operative to receive and process media requests from a plurality of subscriber devices, each subscriber device comprising at least a media renderer and a user interface; and
one or more virtual set-top boxes (vSTBs) associated with a plurality of subscribers,
the control plane manager further operating to:
determine if a request from a subscriber device for a particular content is for content that already exists at one or more vSTBs hosted in the data center;
if so, select an optimal vSTB that already supports a stream of the requested particular content; and
effectuate a media session to the subscriber device for streaming the requested particular content from the selected optimal vSTB.

2. The data center as recited in claim 1, wherein the control plane manager is further operative to effectuate a media session to the subscriber device for streaming the requested particular content from a media service operator's server when there is no vSTB already supporting the requested particular content.

3. The data center as recited in claim 1, further comprising, if there is no vSTB already supporting the requested particular content, mapping streaming from a central media server into at least one of an existing vSTB or a newly instantiated vSTB and optionally storing the particular content at the newly instantiated vSTB as determined by the control plane manager.

4. The data center as recited in claim 1, wherein the control plane manager is further operative to determine an optimal vSTB with respect to the requested particular content based on at least one of a location of the subscriber device relative to the vSTBs, location of other vSTBs associated with the subscriber, network congestion, latency, jitter and bandwidth conditions between the subscriber device and the vSTBs, service-level agreement (SLA) parameters between the subscriber device and the vSTBs, and capability characteristics of the subscriber device.

5. The data center as recited in claim 1, wherein the vSTBs are organized into at least one of (i) one or more virtual local area networks (VLANs), (ii) one or more Ethernet local area networks (E-LANs), (iii) one or more Virtual Private LAN Service (VPLS) networks, (iv) one or more Ethernet Virtual Private Networks (EVPNs), (v) one or more Layer-2 VPNs (L2VPNs), and (vi) one or more Layer-3 VPNs (L3VPNs).

6. The data center as recited in claim 1, wherein the vSTBs are organized in a peer-to-peer (P2P) network architecture having at least one vSTB operating as an uploader node and at least one vSTB operating as a downloader node.

7. The data center as recited in claim 6, wherein the P2P network architecture is operative with at least one protocol comprising BitTorrent protocol, BitCoin protocol, DirectConnect protocol, Ares protocol, FastTrack protocol, Gnutella protocol, OpenNap protocol, eDonkey protocol, and Rshare protocol.

8. The data center as recited in claim 1, wherein the vSTBs are organized in a Software-Defined Network (SDN)-compliant architecture.

9. The data center as recited in claim 8, wherein the SDN-compliant architecture is operative with at least one of the OpenFlow protocol, Forwarding and Control Element Separation (ForCES) protocol, and OpenDaylight protocol.

10. The data center as recited in claim 1, wherein the requested particular content comprises at least one of a live media program, a stored media on demand program, an Over-The-Top (OTT) program, and a time-shifted TV (TSTV) program.

11. The data center as recited in claim 1, wherein the media session is effectuated over at least one of a wired communications network, a power line communications network, a mobile communications network, a private content delivery network, a public content delivery network, a hybrid content delivery network, a managed IPTV media delivery network, and an unmanaged OTT media delivery network, using at least one of multicast adaptive bitrate streaming, unicast adaptive bitrate streaming, progressive download technology, and Transport Stream (TS) transmission technology.

12. A method for facilitating media streaming in a network environment, comprising:
receiving a request for a particular content from a subscriber device;
determining if the request is for content that already exists at one or more virtual set-top boxes (vSTBs) hosted by a media service data center associated with a plurality of subscribers;
if so, selecting an optimal vSTB that already supports a stream of the requested particular content; and
effectuating a media session to the subscriber device for streaming the requested particular content from the selected optimal vSTB.

13. The method as recited in claim 12, further comprising effectuating a media session to the subscriber device for streaming the requested particular content from a media service operator's server when there is no vSTB already supporting the requested particular content.

14. The method as recited in claim 12, further comprising, if there is no vSTB already supporting the requested particular content, mapping streaming from a central media server into at least one of an existing vSTB or a newly instantiated vSTB and optionally storing the particular content at the newly instantiated vSTB as determined by the control plane manager.

15. The method as recited in claim 12, further comprising determining an optimal vSTB with respect to the requested particular content based on at least one of a location of the subscriber device relative to the vSTBs, location of other vSTBs associated with the subscriber, network congestion, latency, jitter and bandwidth conditions between the subscriber device and the vSTBs, service-level agreement (SLA) parameters between the subscriber device and the vSTBs, and capability characteristics of the subscriber device.

16. The method as recited in claim 12, further comprising:
determining whether the particular content requires further processing based on at least one of capability characteristics of the subscriber device and a content delivery network; and
if so, locating a vSTB that already contains the processed particular content compliant with at least one of the capability characteristics of the subscriber device and the content delivery network, and using the vSTB as the optimal vSTB for streaming the particular content.

17. The method as recited in claim 16, wherein the particular content is further processed based on at least one of transcoding, resegmentation, and using a different streaming protocol compatible with the subscriber device.

18. The method as recited in claim 12, wherein the requested particular content comprises at least one of a live media program, a stored media on demand program, an Over-The-Top (OTT) program, and a time-shifted TV (TSTV) program.

19. The method as recited in claim 12, wherein the media session is effectuated over at least one of a wired communications network, a power line communications network, a mobile communications network, a private content delivery network, a public content delivery network, a hybrid content delivery network, a managed IPTV media delivery network, and an unmanaged OTT media delivery network, using at least one of multicast adaptive bitrate streaming, unicast adaptive bitrate streaming, progressive download technology, and Transport Stream (TS) transmission technology.

20. A system for facilitating media streaming in a network environment including a plurality of set-top boxes (STBs), the system comprising:
a control plane manager operative to receive and process media requests from the plurality of STBs, each STB including at least a media renderer, a user interface and a local database storage of content downloaded for rendering thereat; and
the control plane manager further operating to:
determine if a request from a first STB for a particular content is for content that already exists at one or more STBs of the network environment;
if so, select an optimal STB that already supports and capable of sharing a stream of the requested particular content; and
effectuate a media session to the first STB for streaming the requested particular content from the selected optimal STB.

21. The system as recited in claim 20, wherein the control plane manager is further operative to effectuate a media session to the first STB for streaming the requested particular content from a media service operator's server when there is no STB already supporting the requested particular content.

22. The system as recited in claim 20, wherein the media session comprises streaming at least one of an entire particular media content, beginning of the particular media content or a part of the particular media content.

23. The system as recited in claim 20, wherein the control plane manager is further operative to determine an optimal STB with respect to the requested particular content based on at least one of a location of the first STB relative to the other STBs, network congestion, latency, jitter and bandwidth conditions between the first STB relative to the other STBs, service-level agreement (SLA) parameters between the first STB and the other STBs, and capability characteristics of the first STB.

24. The system as recited in claim 20, wherein the STBs are interconnected as at least one of (i) one or more virtual local area networks (VLANs), (ii) one or more Ethernet local area networks (E-LANs), (iii) one or more Virtual Private LAN Service (VPLS) networks, (iv) one or more Ethernet Virtual Private Networks (EVPNs), (v) one or more Layer-2 VPNs (L2VPNs), and (vi) one or more Layer-3 VPNs (L3VPNs).

25. The system as recited in claim 20, wherein the STBs are interconnected as a peer-to-peer (P2P) network architecture having at least one STB operating as an uploader node and at least one STB operating as a downloader node.

26. The system as recited in claim 25, wherein the P2P network architecture is operative with at least one protocol comprising BitTorrent protocol, BitCoin protocol, DirectConnect protocol, Ares protocol, FastTrack protocol, Gnutella protocol, OpenNap protocol, eDonkey protocol, and Rshare protocol.

27. The system as recited in claim 20, wherein the STBs and the control plane manager are organized in a Software-Defined Network (SDN)-compliant architecture operative with at least one of the OpenFlow protocol, Forwarding and Control Element Separation (ForCES) protocol, and OpenDaylight protocol.

28. The system as recited in claim 20, wherein at least a first portion of the STBs comprise one or more thin client STBs that correspond to one or more virtual STBs instantiated in a data center of the network environment hosted by one or more servers and at least a second portion of the STBs comprise one or more thick client physical STBs (pSTBs).

29. The system as recited in claim 28, wherein the control plane manager is adaptive to service media requests from one or more thin client STBs in addition to media requests from the pSTBs.

30. The system as recited in claim 29, wherein a media request from one of a thin client STB or a pSTB for a particular media content requested by a subscriber is at least partially serviced via a vSTB associated with the subscriber, a vSTB associated with another subscriber, a pSTB associated with the subscriber, a pSTB associated with another subscriber, or from the media service operator's streaming server.

31. The system as recited in claim 30, wherein the requested particular media content comprises at least one of a live media program, a stored media on demand program, an Over-The-Top (OTT) program, and a time-shifted TV (TSTV) program.

32. The system as recited in claim 30, wherein the requested particular media content is delivered over at least one of a wired communications network, a power line communications network, a mobile communications network, a private content delivery network, a public content delivery network, a hybrid content delivery network, a managed IPTV media delivery network, and an unmanaged OTT media delivery network, using at least one of multicast adaptive bitrate streaming, unicast adaptive bitrate streaming, progressive download technology, and Transport Stream (TS) transmission technology.
